(19) United States
(12) Patent Application Publication
(10) Pub. No.: US 2026/0126800 A1
(43) Pub. Date: May 7, 2026

(54) Object Detection for Autonomous Vehicles

(71) Applicant: Aurora Operations, Inc., Pittsburgh, PA (US)

(72) Inventors: Steven Ziqiu Chen, Austin, TX (US); Nemanja Djuric, Pittsburgh, PA (US); Jiaxi Nie, Mountain View, CA (US)

(21) Appl. No.: 18/934,731

(22) Filed: Nov. 1, 2024

(51) Int. Cl. G05D 1/43; B60W 60/00; G06V 10/20

(52) U.S. Cl. CPC G05D 1/43; B60W 60/001; G06V 10/255

(57) ABSTRACT

An example method includes generating, a first bounding shape for an object within an environment of an autonomous vehicle, the first bounding shape indicating a boundary corresponding to a shape of the object. The example method includes identifying an extension of the object outside the boundary corresponding to the shape of the object. The example method includes generating, based on the first bounding shape, a second bounding shape for the object, the extension of the object enclosed in an interior region of the second bounding shape. The example method includes generating, based on the second bounding shape, a motion plan for the autonomous vehicle to control the motion of the autonomous vehicle relative to the second bounding shape. The example method includes providing instructions to control the motion of the autonomous vehicle in accordance with the motion plan.

### BACKGROUND

A self-driving car may use computer vision techniques to understand the surroundings of the self-driving car and use computers to decide how to drive with respect to the surroundings.

### SUMMARY

The present disclosure is directed to improving the ability of an autonomous vehicle to detect the shapes of objects within the environment of the vehicle and control the motion of the autonomous vehicle through the environment. For example, an autonomous vehicle may process sensor data to detect an object within the surrounding environment (e.g., a pick-up truck in an adjacent lane). The autonomous vehicle may generate a first bounding shape (e.g., bounding box) that corresponds to the shape of the object. For example, the first bounding shape may represent a canonical shape fit tightly to the main volume of the object. The dimensions of the first bounding shape may be based on the classification of the object (e.g., pedestrian, tractor trailer). However, real-world objects may not always conform to canonical shapes. Because the bounding box is tightly fit to the main volume of the object, there may be an extension protruding from the object (e.g., a pole in the truck bed) that extends outside the boundary defining the canonical shape.

The technology of the present disclosure allows an autonomous vehicle to better account for such extensions. For example, the autonomous vehicle may process the sensor data and the first bounding shape to determine that there is an extension of the object that extends outside the first bounding shape. To do so, the autonomous vehicle may analyze image pixels to determine that certain colored pixels appear to extend from the object and are present outside the first bounding shape. Additionally, or alternatively, the autonomous vehicle may analyze a LIDAR point cloud return and determine that a certain density of LIDAR points exist for a structure that extends outside the first bounding shape.

To account for the extension, the autonomous vehicle may generate a second bounding shape based on the first bounding shape. The second bounding shape may include, for example, a single box/rectangular prism that is axis aligned to the first bounding shape (e.g., the canonical bounding box), but that includes a larger interior region than the first bounding shape. The outermost exterior surface of the extension from the object may be enclosed in the larger, second bounding shape. This helps capture the observed shape of the object, including the actual extremities of the object. In some implementations, the second bounding shape may be oriented slightly differently or offset from the first bounding box to better reflect the observed shape of the object.

The autonomous vehicle may generate the second bounding shape by transforming a portion of the first bounding shape. This may include shifting one or more sides of the first bounding shape away from the centroid of the first bounding shape. A side may be shifted until it reaches the outermost surface of the extension.

The autonomous vehicle may transform certain portions of the first bounding shape that are “relevant” to the autonomous vehicle. A portion of the first bounding shape may be considered relevant, in the event that the portion includes the extension and is visible to the autonomous vehicle (e.g., within the field of view of a sensor of the autonomous vehicle).

In some implementations, the autonomous vehicle may analyze the angle between the autonomous vehicle and a portion of the first bounding shape to help determine whether to perform a transformation. By way of example, the first bounding shape may include a four-sided bounding box that represents the canonical shape of an object. The object may be a pick-up truck that includes a pole extending out of the left side of the truck bed and a piece of lumber extending from the backside of the truck. The autonomous vehicle may be travelling on the diagonal front left side of the truck (e.g., in an adjacent left lane). Accordingly, the angle between the autonomous vehicle and the left side of the truck may be less than an angle threshold, indicating good visibility. The angle between the autonomous vehicle and the backside of the truck may be greater than the angle threshold, indicating poor visibility. Thus, to generate the second bounding shape, the left side of the first bounding shape may be shifted outward until the entirety of the extended pole is enclosed within the region of the bounding shape, while the back side of the first bounding shape, which is less visible, may be unmodified. The second bounding shape may include the transformed version of the first bounding shape.

The autonomous vehicle may generate the second bounding shape based on a trained model. The model may be trained based on labeled training data. For example, the training data may include previously captured sensor data. The sensor data may indicate a training object within an environment (e.g., a truck travelling on a highway). The training object may have an extension protruding from the object (e.g., a pole extending from the truck). The training data may include a first training shape that is labeled as representing the canonical shape of the object and a second training shape that is labeled as representing the observed shape of the object. These labels may be automatically generated based on the techniques described herein. The extension protruding from the object may extend beyond the boundary of the first training shape, but may be included within the second training shape. A computing system may train the model by applying supervised training techniques based on the labeled training data. Accordingly, the model may learn to predict transforms and offsets from the canonical bounding shape to generate a bounding shape indicative of the observed shape of an object.

Based on the second bounding shape, the autonomous vehicle may generate a motion plan for the autonomous vehicle. The motion plan may include parameter(s) to control the motion of the vehicle. This may include a motion trajectory with waypoints for the autonomous vehicle to navigate over the next few seconds. For instance, an onboard perception system may provide data indicative of the second bounding box to a motion planner. The motion planner may generate a motion trajectory based on the second bounding box. The motion trajectory may include a plurality of waypoints for the autonomous vehicle to follow to provide a proper clearance from the extension of the object (e.g., the pole extending from the truck bed). The motion planner may provide instructions to the actuator controllers of the autonomous vehicle to control the heading and speed of the autonomous vehicle to follow the trajectory.

In some implementations, the autonomous vehicle may also process the first bounding shape to help generate a motion plan for the vehicle. For instance, the motion planner may process the first bounding shape to determine that the object is within a particular lane on a highway, and process the second bounding shape to determine the proper clearance for passing the object (and its extension) while the object is travelling in that lane.

Overall, object detection and perception may pose a number of technical challenges for autonomous vehicles. For instance, an example system may consider accounting for object extremities by providing a conservative set halo/buffer around each object. As a result, the autonomous vehicle may be unnecessarily prevented, or delayed, from passing objects. This can lead to latency and computational waste onboard the vehicle because the autonomous vehicle may be forced to continuously process the same scene.

In another example, a system may consider using only canonical bounding boxes that do not take into account object extensions. Such an example system may consider instead relying on alternative mitigation systems to recognize extensions and adjust the motion of the autonomous vehicle in a shorter time frame. While this may allow for overall consistent operation within the environment, it may also lead to increased computational burden on the secondary systems of the autonomous vehicle as well as increased wear and tear on the mechanical systems of the vehicle due to short term motion overrides.

The technology of the present disclosure provides a technical solution to these technical problems. For instance, as described herein, an autonomous vehicle may analyze an individual object to determine whether there are any extensions protruding from the object and whether the extension is located on a side of the object that is relevant to the autonomous vehicle (e.g., as indicated by the angle between the object and the vehicle). If so, the autonomous vehicle may generate a second bounding shape to account for the extension. This allows the autonomous vehicle to selectively generate additional bounding shapes, where appropriate, and, thus, more efficiently utilize its limited onboard processing resources. This also allows the autonomous vehicle to account for object extensions earlier in the autonomy pipeline of the autonomous vehicle leading to improved motion planning.

The technology of the present disclosure improves the ability of the autonomous vehicle to navigate through the environment of the autonomous vehicle. The autonomous vehicle (e.g., an onboard motion planner) may utilize the second bounding shape to generate a motion plan that proactively accounts for any object extensions that may affect the path of the vehicle. For example, the autonomous vehicle may generate a motion trajectory that navigates the autonomous vehicle around an object, which includes an extension, with limited jerk acceleration. This allows the autonomous vehicle to appropriately pass objects, without hesitation and without wasteful scene re-processing. Moreover, the proactive motion plans and smooth trajectories may reduce the wear and tear on the mechanical systems of the autonomous vehicle. In this way, the systems and methods of the present disclosure provide numerous technical effects as practically applied to autonomous vehicles.

The technology of the present disclosure improves computing technology, including autonomous vehicle computing technology. For instance, as described herein, the systems and methods of the present disclosure improve the efficiency of the onboard computing system of an autonomous vehicle by reducing computational re-work as well as the processing loads on secondary systems. These efficiency gains in processing may reduce the consumption of the limited memory and power resources that are onboard the autonomous vehicle. In this way, the computing system of the autonomous vehicle is able to more effectively observe the surroundings of the vehicle and control the motion of the vehicle.

For example, in an aspect, the present disclosure provides an example method for detecting an object. In some implementations, the example computer-implemented method includes generating, based on data indicative of an object within an environment of an autonomous vehicle, a first bounding shape for the object, the first bounding shape indicating a boundary corresponding to a shape of the object. In some implementations, the example method includes identifying, based on the data indicative of the object and the first bounding shape, an extension of the object outside the boundary corresponding to the shape of the object. In some implementations, the example method includes generating, based on the first bounding shape, a second bounding shape for the object, the extension of the object enclosed in an interior region of the second bounding shape. In some implementations, the example method includes generating, based on the second bounding shape, a motion plan for the autonomous vehicle, the motion plan including one or more parameters to control the motion of the autonomous vehicle relative to the second bounding shape. In some implementations, the example method includes providing one or more instructions to control the motion of the autonomous vehicle in accordance with the one or more parameters of the motion plan.

In some implementations, the example method includes determining, based on the extension, a first portion of the first bounding shape at which the extension is located. In some implementations, the example method includes performing a transformation on the first portion of the first bounding shape. In some implementations, the example method includes generating the second bounding shape to include the first portion of the first bounding shape that has been transformed, such that an outer surface of the extension is included in the interior region of the second bounding shape.

In some implementations of the example method, the first portion of the first bounding shape is a first side of the first bounding shape. In some implementations of the example method the transformation includes shifting the first side of the first bounding shape away from a centroid of the first bounding shape.

In some implementations, the example method includes determining that the first portion of the first bounding shape is within a field of view of a sensor of the autonomous vehicle.

In some implementations, the example method includes determining a first angle between the autonomous vehicle and a first portion of the first bounding shape of the object at which the extension is located. In some implementations, the example method includes generating a comparison of the first angle to an angle threshold. In some implementations, the example method includes based on the comparison of the first angle to the angle threshold, generating the second bounding shape based on the first bounding shape.

In some implementations of the example method, the comparison of the first angle to the angle threshold indicates that the first angle is less than the angle threshold.

In some implementations, the example method includes determining a second angle between the autonomous vehicle and a second portion of the first bounding shape of the object. In some implementations, the example method includes generating a comparison of the second angle to the angle threshold. In some implementations, the example method includes, based on the comparison of the second angle to the angle threshold, determining to forgo transforming the second portion of the first bounding shape.

In some implementations of the example method, the comparison of the second angle to the angle threshold indicates that the second angle is greater than the angle threshold.

In some implementations, the example method includes determining, based on the first bounding shape, an estimated position of the object within a roadway.

In some implementations, the example method includes generating, also based on the estimated position of the object within the roadway, the motion plan for the autonomous vehicle.

In some implementations, the example method includes determining, based on the data indicative of the object, that the object is not an ephemeral object.

In some implementations of the example method, the extension includes at least one of a protrusion of an item being transported by the object or a protrusion of a component of the object.

In some implementations of the example method, the second bounding shape includes a larger region than the first bounding shape.

In some implementations, the example method includes generating the first bounding shape based on a classification of the object.

In some implementations, the example method includes generating the second bounding box based on a model, the model being trained based on labeled training data, the labeled training data including a training object with a training extension. The labeled training data can include a first training shape representing a canonical shape of the training object and a second training shape representing a shape of the training object that includes the extension of the training object.

For example, in an aspect, the present disclosure provides an example autonomous vehicle control system. The example autonomous vehicle control system includes one or more processors and one or more non-transitory computer-readable media storing instructions that are executable by the one or more processors to perform operations. The operations include generating, based on data indicative of an object within an environment of an autonomous vehicle, a first bounding shape for the object, the first bounding shape indicating a boundary corresponding to a shape of the object. The operations include identifying, based on the data indicative of the object and the first bounding shape, an extension of the object outside the boundary corresponding to the shape of the object; generating, based on the first bounding shape, a second bounding shape for the object, the extension of the object enclosed in an interior region of the second bounding shape. The operations include generating, based on the second bounding shape, a motion plan for the autonomous vehicle, the motion plan including one or more parameters to control the motion of the autonomous vehicle relative to the second bounding shape. The operations include providing one or more instructions to control the motion of the autonomous vehicle in accordance with the one or more parameters of the motion plan.

In some implementations, the operations include determining a portion of the first bounding shape at which the extension is located. In some implementations, the operations include performing a transformation on the portion of the first bounding shape at which the extension is located. In some implementations, the operations include and generating, based on the portion of the first bounding shape that has been transformed, the second bounding shape, such that an outer surface of the extension is included in the interior region of the second bounding shape.

In some implementations, the first portion of the first bounding shape is a first side of the first bounding shape. In some implementations, the transformation includes shifting the first side of the first bounding shape away from a centroid of the first bounding shape until an entirety of the extension is included in the interior region of the second bounding shape.

In some implementations the operations include determining a first angle between the autonomous vehicle and a first portion of the first bounding shape of the object at which the extension is located. In some implementations, the operations include generating a comparison of the first angle to an angle threshold. In some implementations, the operations include, based on the comparison of the first angle to the angle threshold, generating the second bounding shape based on the first bounding shape.

For example, in an aspect, the present disclosure provides for one or more example non-transitory computer-readable media storing instructions that are executable to cause one or more processors to perform operations. In some implementations, the operations include generating, based on data indicative of an object within an environment of an autonomous vehicle, a first bounding shape for the object, the first bounding shape indicating a boundary corresponding to a shape of the object. The operations include identifying, based on the data indicative of the object and the first bounding shape, an extension of the object outside the boundary corresponding to the shape of the object. The operations include generating, based on the first bounding shape, a second bounding shape for the object, the extension of the object enclosed in an interior region of the second bounding shape. The operations include generating, based on the second bounding shape, a motion plan for the autonomous vehicle, the motion plan including one or more parameters to control the motion of the autonomous vehicle relative to the second bounding shape. The operations include providing one or more instructions to control the motion of the autonomous vehicle in accordance with the one or more parameters of the motion plan

Other example aspects of the present disclosure are directed to other systems, methods, vehicles, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 is a block diagram of an example operational scenario, according to some implementations of the present disclosure;

FIG. 2 is a block diagram of an example system, according to some implementations of the present disclosure;

FIG. 3A is a representation of an example operational environment, according to some implementations of the present disclosure;

FIG. 3B is a representation of an example map of an operational environment, according to some implementations of the present disclosure;

FIG. 3C is a representation of an example operational environment, according to some implementations of the present disclosure;

FIG. 3D is a representation of an example map of an operational environment, according to some implementations of the present disclosure;

FIG. 4 is a block diagram of an object detection and tracking system, according to some implementations of the present disclosure;

FIGS. 5A-B are representations of an example object observation, according to some implementations of the present disclosure;

FIGS. 6A-C are representations of an example object observation, according to some implementations of the present disclosure;

FIGS. 7A-10 are a flowcharts of example methods, according to some implementations of the present disclosure;

FIG. 11 is a block diagram of an example computing system, according to some implementations of the present disclosure.

### DETAILED DESCRIPTION

The following describes the technology of this disclosure within the context of an autonomous vehicle for example purposes only. As described herein, the technology described herein is not limited to an autonomous vehicle and may be implemented for or within other autonomous platforms and other computing systems.

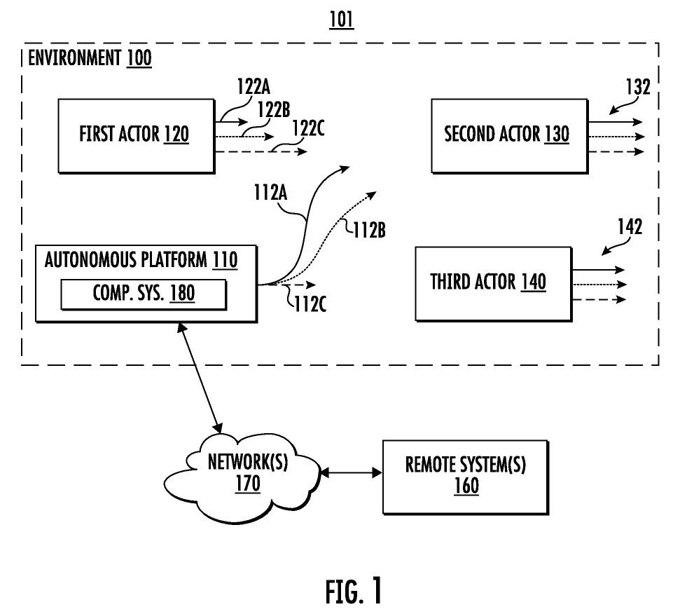

With reference to FIG. 1–10, example embodiments of the present disclosure are discussed in further detail. FIG. 1 is a block diagram 101 of an example operational scenario according to example implementations of the present disclosure. In the example operational scenario, an environment 100 contains an autonomous platform 110 and a number of objects, including first actor 120, second actor 130, and third actor 140. In the example operational scenario, the autonomous platform 110 may move through the environment 100 and interact with the object(s) that are located within the environment 100 (e.g., first actor 120, second actor 130, third actor 140). The autonomous platform 110 may optionally be configured to communicate with remote system(s) 160 through network(s) 170.

The environment 100 may be or include an indoor environment (e.g., within one or more facilities.) or an outdoor environment. An indoor environment, for example, may be an environment enclosed by a structure such as a building (e.g., a service depot, maintenance location, manufacturing facility). An outdoor environment, for example, may be one or more areas in the outside world such as, for example, one or more rural areas (e.g., with one or more rural travel ways), one or more urban areas (e.g., with one or more city travel ways, highways), one or more suburban areas (e.g., with one or more suburban travel ways), or other outdoor environments.

The autonomous platform 110 may be any type of platform configured to operate within the environment 100. For example, the autonomous platform 110 may be a vehicle configured to autonomously perceive and operate within the environment 100. The vehicles may be a ground-based autonomous vehicle such as, for example, an autonomous car, truck, van, or other vehicle type. The autonomous platform 110 may be an autonomous vehicle that may control, be connected to, or be otherwise associated with implements, attachments, and/or accessories for transporting people or cargo. This may include, for example, an autonomous tractor optionally coupled to a cargo trailer. Additionally or alternatively, the autonomous platform 110 may be any other type of vehicle such as one or more aerial vehicles, water-based vehicles, space-based vehicles, or other ground-based vehicles.

The autonomous platform 110 may be configured to communicate with the remote system(s) 160. For instance, the remote system(s) 160 may communicate with the autonomous platform 110 for assistance (e.g., navigation assistance, situation response assistance), control (e.g., fleet management, remote operation), maintenance (e.g., updates, monitoring), or other local or remote tasks. In some implementations, the remote system(s) 160 may provide data indicating tasks that the autonomous platform 110 should perform. For example, as further described herein, the remote system(s) 160 may provide data indicating that the autonomous platform 110 is to perform a trip/service such as a user transportation trip/service, delivery trip/service (e.g., for cargo, freight, items), or other service.

The autonomous platform 110 may communicate with the remote system(s) 160 using the network(s) 170. The network(s) 170 may facilitate the transmission of signals (e.g., electronic signals) or data (e.g., data from a computing device) and may include any combination of various wired (e.g., twisted pair cable) or wireless communication mechanisms (e.g., cellular, wireless, satellite, microwave, radio frequency) or any desired network topology (or topologies). For example, the network(s) 170 may include a local area network (e.g., intranet), a wide area network (e.g., the Internet), a wireless LAN network (e.g., through Wi-Fi), a cellular network, a SATCOM network, a VHF network, a HF network, a WiMAX based network, or any other suitable communications network (or combination thereof) for transmitting data to or from the autonomous platform 110.

As shown for example in FIG. 1, the environment 100 may include one or more objects. The object(s) may be objects not in motion or not predicted to move (“static objects”) or object(s) in motion or predicted to be in motion (“dynamic objects” or “actors”). In some implementations, the environment 100 may include any number of actor(s) such as, for example, one or more pedestrians, animals, vehicles, trailers, or other actor types. An object may include one or more portions. For example, a truck including a tractor pulling a trailer may be identified as a single object, with multiple portions: a first portion (e.g., tractor) and a second portion (e.g., trailer). In some implementations, the portions may be identified as separate objects. For example, a tractor may be identified as a first object and a trailer (being pulled by the tractor) may be identified as a separate, second object. In another example, an open door of a vehicle may be identified as a separate object from the vehicle or as an extension of the vehicle, as further described herein.

The actor(s) may move within the environment according to one or more actor trajectories. For instance, the first actor 120 may move along any one of the first actor trajectories 122A–C, the second actor 130 may move along any one of the second actor trajectories 132, and the third actor 140 may move along any one of the third actor trajectories 142. In an embodiment, the actor(s) may include extensions which extend from the main volume of the object. These extensions may be considered as the autonomous platform 110 traverses the environment 100.

As further described herein, the autonomous platform 110 may utilize its autonomy system(s) to detect these actors (and their movement), their extensions, and plan its motion to navigate through the environment 100 according to one or more platform trajectories 112A–C. The autonomous platform 110 may include onboard computing system(s) 180. The onboard computing system(s) 180 may include one or more processors and one or more memory devices. The one or more memory devices may store instructions executable by the one or more processors to cause the one or more processors to perform operations or functions associated with the autonomous platform 110, including implementing its autonomy system(s).

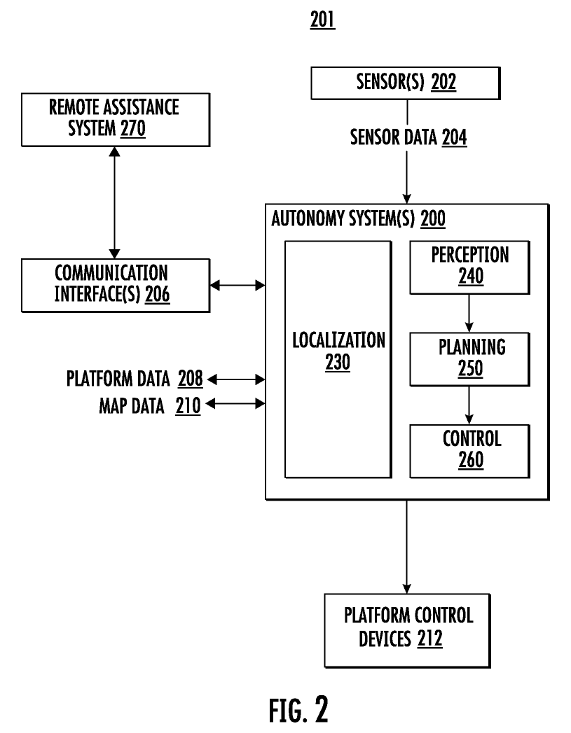

FIG. 2 is a block diagram 201 of an example autonomy system 200 for an autonomous platform, according to some implementations of the present disclosure. In some implementations, the autonomy system 200 may be implemented by a computing system of the autonomous platform (e.g., the onboard computing system(s) 180 of the autonomous platform 110). The autonomy system 200 may operate to obtain inputs from sensor(s) 202 or other input devices. In some implementations, the autonomy system 200 may additionally obtain platform data 208 (e.g., map data 210) from local or remote storage. The autonomy system 200 may generate control outputs for controlling the autonomous platform (e.g., through platform control devices 212) based on sensor data 204, map data 210, or other data.

The autonomy system 200 may include different subsystems for performing various autonomy operations. The subsystems may include a localization system 230, a perception system 240, a planning system 250, and a control system 260. The localization system 230 may determine the location of the autonomous platform within its environment; the perception system 240 may detect, classify, and track objects in the environment; the planning system 250 may determine a trajectory for the autonomous platform; and the control system 260 may translate the trajectory into vehicle controls for controlling the autonomous platform. The autonomy system 200 may be implemented by one or more onboard computing system(s). The subsystems may include one or more processors and one or more memory devices. The one or more memory devices may store instructions executable by the one or more processors to cause the one or more processors to perform operations or functions associated with the subsystems. The computing resources of the autonomy system 200 may be shared among its subsystems, or a subsystem may have a set of dedicated computing resources.

In some implementations, the autonomy system 200 may be implemented for or by an autonomous vehicle (e.g., a ground-based autonomous vehicle). The autonomy system 200 may perform various processing techniques on inputs (e.g., the sensor data 204, the map data 210) to perceive and understand the vehicle’s surrounding environment and generate an appropriate set of control outputs to implement a vehicle motion plan (e.g., including one or more trajectories) for traversing the vehicle’s surrounding environment (e.g., environment 100 of FIG. 1). In some implementations, an autonomous vehicle implementing the autonomy system 200 may drive, navigate, or operate, with minimal or no interaction from a human operator (e.g., driver, pilot).

In some implementations, the autonomous platform may be configured to operate in a plurality of operating modes. For instance, the autonomous platform may be configured to operate in a fully autonomous operating mode in which the autonomous platform is controllable without user input (e.g., may drive and navigate with no input from a human operator present in the autonomous vehicle or remote from the autonomous vehicle). The autonomous platform may operate in a semi-autonomous operating mode in which the autonomous platform may operate with some input from a human operator present in the autonomous platform (or a human operator that is remote from the autonomous platform). In some implementations, the autonomous platform may enter into a manual operating mode in which the autonomous platform is fully controllable by a human operator (e.g., human driver) and may be prohibited or disabled (e.g., temporary, permanently) from performing autonomous navigation (e.g., autonomous driving). The autonomous platform may be configured to operate in other modes such as, for example, park or sleep modes (e.g., for use between tasks such as waiting to provide a trip/service, recharging). In some implementations, the autonomous platform may implement vehicle operating assistance technology (e.g., collision mitigation system, power assist steering), for example, to help assist the human operator of the autonomous platform (e.g., while in a manual mode).

The autonomy system 200 may be located onboard (e.g., on or within) an autonomous platform and may be configured to operate the autonomous platform in various environments. The environment may be a real-world environment or a simulated environment. In some implementations, one or more simulation computing devices may simulate one or more of: the sensors 202, the sensor data 204, communication interface(s) 206, the platform data 208, or the platform control devices 212 for simulating operation of the autonomy system 200.

In some implementations, the autonomy system 200 may communicate with one or more networks or other systems with the communication interface(s) 206. The communication interface(s) 206 may include any suitable components for interfacing with one or more network(s) (e.g., the network(s) 170 of FIG. 1), including, for example, transmitters, receivers, ports, controllers, antennas, or other suitable components that may help facilitate communication. In some implementations, the communication interface(s) 206 may include a plurality of components (e.g., antennas, transmitters, receivers) that allow it to implement and utilize various communication techniques (e.g., multiple-input, multiple-output (MIMO) technology).

In some implementations, the autonomy system 200 may use the communication interface(s) 206 to communicate with one or more computing devices that are remote from the autonomous platform (e.g., the remote system(s) 160) over one or more network(s) (e.g., the network(s) 170). For instance, in some examples, one or more inputs, data, or functionalities of the autonomy system 200 may be supplemented or substituted by a remote system communicating over the communication interface(s) 206. For instance, in some implementations, the map data 210 may be downloaded over a network to a remote system using the communication interface(s) 206. In some examples, one or more of the localization system 230, the perception system 240, the planning system 250, or the control system 260 may be updated, influenced, nudged, or communicated with, by a remote system for assistance, maintenance, situational response override, management, or other purposes.

The sensor(s) 202 may be located onboard the autonomous platform. In some implementations, the sensor(s) 202 may include one or more types of sensor(s). For instance, one or more sensors may include image capturing device(s) (e.g., visible spectrum cameras, infrared cameras). Additionally or alternatively, the sensor(s) 202 may include one or more depth capturing device(s). For example, the sensor(s) 202 may include one or more Light Detection and Ranging (LIDAR) sensor(s) or Radio Detection and Ranging (RADAR) sensor(s). The sensor(s) 202 may be configured to generate point data descriptive of at least a portion of a three-hundred-and-sixty-degree view of the surrounding environment. The point data may be point cloud data (e.g., three-dimensional LIDAR point cloud data, RADAR point cloud data). In some implementations, one or more of the sensor(s) 202 for capturing depth information may be fixed to a rotational device in order to rotate the sensor(s) 202 about an axis. The sensor(s) 202 may be rotated about the axis while capturing data in interval sector packets descriptive of different portions of a three-hundred-and-sixty-degree view of a surrounding environment of the autonomous platform. In some implementations, one or more of the sensor(s) 202 for capturing depth information may be solid state.

The sensor(s) 202 may be configured to capture the sensor data 204 indicating or otherwise being associated with at least a portion of the environment of the autonomous platform. The sensor data 204 may include image data (e.g., 2D camera data, video data), RADAR data, LIDAR data (e.g., 3D point cloud data), audio data, or other types of data. In some implementations, the autonomy system 200 may obtain input from additional types of sensors, such as inertial measurement units (IMUs), altimeters, inclinometers, odometry devices, location or positioning devices (e.g., GPS, compass), wheel encoders, or other types of sensors. In some implementations, the autonomy system 200 may obtain sensor data 204 associated with particular component(s) or system(s) of an autonomous platform. This sensor data 204 may indicate, for example, wheel speed, component temperatures, steering angle, cargo or passenger status. In some implementations, the autonomy system 200 may obtain sensor data 204 associated with ambient conditions, such as environmental or weather conditions. In some implementations, the sensor data 204 may include multi-modal sensor data. The multi-modal sensor data may be obtained by at least two different types of sensor(s) (e.g., of the sensors 202) and may indicate static object(s) within an environment of the autonomous platform. The multi-modal sensor data may include at least two types of sensor data (e.g., camera and LIDAR data). In some implementations, the autonomous platform may utilize the sensor data 204 for sensors that are remote from (e.g., offboard) the autonomous platform. This may include, for example, sensor data 204 captured by a different autonomous platform.

The autonomy system 200 may obtain the map data 210 associated with an environment in which the autonomous platform was, is, or will be located. The map data 210 may provide information about an environment or a geographic area. For example, the map data 210 may provide information regarding the identity and location of different travel ways (e.g., roadways), travel way segments (e.g., road segments), buildings, or other items or objects (e.g., lampposts, crosswalks, curbs); the location and directions of boundaries or boundary markings (e.g., the location and direction of traffic lanes, parking lanes, turning lanes, bicycle lanes, other lanes); traffic control data (e.g., the location and instructions of signage, traffic lights, other traffic control devices); obstruction information (e.g., temporary or permanent blockages); event data (e.g., road closures/traffic rule alterations due to parades, concerts, sporting events); nominal vehicle path data (e.g., indicating an ideal vehicle path such as along the center of a certain lane); or any other map data that provides information that assists an autonomous platform in understanding its surrounding environment and its relationship thereto. In some implementations, the map data 210 may include high-definition map information. Additionally or alternatively, the map data 210 may include sparse map data (e.g., lane graphs). In some implementations, the sensor data 204 may be fused with or used to update the map data 210 in online or offline.

The autonomy system 200 may include the localization system 230, which may provide an autonomous platform with an understanding of its location and orientation in an environment. In some examples, the localization system 230 may support one or more other subsystems of the autonomy system 200, such as by providing a unified local reference frame for performing, e.g., perception operations, planning operations, or control operations.

In some implementations, the localization system 230 may determine a current position of the autonomous platform. A current position may include a global position (e.g., respecting a georeferenced anchor) or relative position (e.g., respecting objects in the environment). The localization system 230 may generally include or interface with any device or circuitry for analyzing a position or change in position of an autonomous platform (e.g., autonomous ground-based vehicle). For example, the localization system 230 may determine position by using one or more of: inertial sensors (e.g., inertial measurement unit(s)), a satellite positioning system, radio receivers, networking devices (e.g., based on IP address), triangulation or proximity to network access points or other network components (e.g., cellular towers, Wi-Fi access points), or other suitable techniques. The position of the autonomous platform may be used by various subsystems of the autonomy system 200 or provided to a remote computing system (e.g., using the communication interface(s) 206).

In some implementations, the localization system 230 may register relative positions of elements of a surrounding environment of an autonomous platform with recorded positions in the map data 210. For instance, the localization system 230 may process the sensor data 204 (e.g., LIDAR data, RADAR data, camera data) for aligning or otherwise registering to a map of the surrounding environment (e.g., from the map data 210) to understand the position of the autonomous platform 110 within that environment. Accordingly, in some implementations, the autonomous platform 110 may identify its position within the surrounding environment (e.g., across six axes) based on a search over the map data 210. In some implementations, given an initial location, the localization system 230 may update the location of the autonomous platform 110 with incremental re-alignment based on recorded or estimated deviations from the initial location. In some implementations, a position may be registered within the map data 210.

The map data 210 may include a large volume of data subdivided into geographic tiles, such that a desired region of a map stored in the map data 210 may be reconstructed from one or more tiles. For instance, a plurality of tiles selected from the map data 210 may be stitched together by the autonomy system 200 based on a position obtained by the localization system 230 (e.g., a number of tiles selected in the vicinity of the position).

In some implementations, the localization system 230 may determine positions (e.g., relative or absolute) of one or more attachments or accessories for an autonomous platform 110. For instance, an autonomous platform 110 may be associated with a cargo platform, and the localization system 230 may provide positions of one or more points on the cargo platform. For example, a cargo platform may include a trailer or other device towed or otherwise attached to or manipulated by an autonomous platform 110, and the localization system 230 may provide for data describing the position (e.g., absolute, relative) of the autonomous platform 110 as well as the cargo platform. Such information may be obtained by the other autonomy systems to help operate the autonomous platform 110.

The autonomy system 200 may include the perception system 240, which may allow an autonomous platform 110 to detect, classify, and track objects in the environment of the autonomous platform 110. Environmental features or objects perceived within an environment may be those within the field of view of the sensor(s) 202 or predicted to be occluded from the sensor(s) 202. This may include object(s) not in motion or not predicted to move (static objects) or object(s) in motion or predicted to be in motion (dynamic objects/actors). In an embodiment, this may include extensions of static object(s) or dynamic objects/actors.

The perception system 240 may determine one or more states (e.g., current or past state(s)) of one or more objects that are within a surrounding environment of an autonomous platform. For example, state(s) may describe (e.g., for a given time, time period) an estimate of an object’s current or past location (also referred to as position); current or past speed/velocity; current or past acceleration; current or past heading; current or past orientation; size/footprint (e.g., as represented by a bounding shape, object highlighting); classification (e.g., pedestrian class vs. vehicle class vs. bicycle class); the uncertainties associated therewith; other state information; or any combination thereof. In some implementations, the perception system 240 may determine the state(s) using one or more algorithms or machine-learned models configured to identify/classify objects based on inputs from the sensor(s) 202. The perception system may use different modalities of the sensor data 204 to generate a representation of the environment to be processed by the one or more algorithms or machine-learned models. In some implementations, state(s) for one or more identified or unidentified objects may be maintained and updated over time as the autonomous platform continues to perceive or interact with the objects (e.g., maneuver with or around, yield to). In this manner, the perception system 240 may provide an understanding about a current state of an environment (e.g., including the objects therein) informed by a record of prior states of the environment (e.g., including movement histories for the objects therein). Such information may be helpful as the autonomous platform plans its motion through the environment.

The autonomy system 200 may include the planning system 250, which may be configured to determine how the autonomous platform 110 is to interact with and move within its environment. The planning system 250 may determine one or more motion plans for an autonomous platform. A motion plan may include one or more trajectories (e.g., motion trajectories) that indicate a path for an autonomous platform to follow. A trajectory may be of a certain length or time range. The length or time range may be defined by the planning system 250. A motion trajectory may be defined by one or more waypoints (with associated coordinates). The waypoint(s) may be future location(s) for the autonomous platform. The motion plans may be continuously generated, updated, and considered by the planning system 250.

The motion planning system 250 may determine a strategy for the autonomous platform. A strategy may be a set of discrete decisions (e.g., yield to actor, reverse yield to actor, merge, lane change) that the autonomous platform makes. The strategy may be selected from a plurality of potential strategies. The selected strategy may be a lowest cost strategy as determined by one or more cost functions. The cost functions may, for example, evaluate the probability of a interfering with another object.

The planning system 250 may determine a desired trajectory for executing a strategy. For instance, the planning system 250 may obtain one or more trajectories for executing one or more strategies. The planning system 250 may evaluate trajectories or strategies (e.g., with scores, costs, rewards, constraints) and rank them. For instance, the planning system 250 may use forecasting output(s) that indicate interactions (e.g., proximity, intersections) between trajectories for the autonomous platform and one or more objects to inform the evaluation of candidate trajectories or strategies for the autonomous platform. In some implementations, the planning system 250 may utilize static cost(s) to evaluate trajectories for the autonomous platform (e.g., “avoid lane boundaries,” “minimize jerk,”). Additionally or alternatively, the planning system 250 may utilize dynamic cost(s) to evaluate the trajectories or strategies for the autonomous platform based on forecasted outcomes for the current operational scenario (e.g., forecasted trajectories or strategies leading to interactions between actors, forecasted trajectories or strategies leading to interactions between actors and the autonomous platform). The planning system 250 may rank trajectories based on one or more static costs, one or more dynamic costs, or a combination thereof. The planning system 250 may select a motion plan (and a corresponding trajectory) based on a ranking of a plurality of candidate trajectories. In some implementations, the planning system 250 may select a highest ranked candidate, or a highest ranked feasible candidate.

The planning system 250 may then validate the selected trajectory against one or more constraints before the trajectory is executed by the autonomous platform 110.

To help with its motion planning decisions, the planning system 250 may be configured to perform a forecasting function. The planning system 250 may forecast future state(s) of the environment. This may include forecasting the future state(s) of other actors in the environment. In some implementations, the planning system 250 may forecast future state(s) based on current or past state(s) (e.g., as developed or maintained by the perception system 240). In some implementations, future state(s) may be or include one or more forecasted trajectories (e.g., positions over time) of the objects in the environment, such as other actors. In some implementations, one or more of the future state(s) may include one or more probabilities associated therewith (e.g., marginal probabilities, conditional probabilities). For example, the one or more probabilities may include one or more probabilities conditioned on the strategy or trajectory options available to the autonomous platform 110. Additionally or alternatively, the probabilities may include probabilities conditioned on trajectory options available to one or more other actors.

In some implementations, the planning system 250 may perform interactive forecasting. The planning system 250 may determine a motion plan for an autonomous platform 110 with an understanding of how forecasted future states of the environment 100 may be affected by execution of one or more candidate motion plans.

By way of example, with reference again to FIG. 1, the autonomous platform 110 may determine candidate motion plans corresponding to a set of platform trajectories 112A–C that respectively correspond to the first actor trajectories 122A–C for the first actor 120, trajectories 132 for the second actor 130, and trajectories 142 for the third actor 140 (e.g., with respective trajectory correspondence indicated with matching line styles). For instance, the autonomous platform 110 (e.g., using its autonomy system 200) may forecast that a platform trajectory 112A to more quickly move the autonomous platform 110 into the area in front of the first actor 120 is likely associated with the first actor 120 decreasing forward speed and yielding more quickly to the autonomous platform 110 in accordance with first actor trajectory 122A. Additionally or alternatively, the autonomous platform 110 may forecast that a platform trajectory 112B to gently move the autonomous platform 110 into the area in front of the first actor 120 is likely associated with the first actor 120 slightly decreasing speed and yielding slowly to the autonomous platform 110 in accordance with first actor trajectory 122B. Additionally or alternatively, the autonomous platform 110 may forecast that a platform trajectory 112C to remain in a parallel alignment with the first actor 120 is likely associated with the first actor 120 not yielding any distance to the autonomous platform 110 in accordance with first actor trajectory 122C. Based on comparison of the forecasted scenarios to a set of desired outcomes (e.g., by scoring scenarios based on a cost or reward), the planning system 250 may select a motion plan (and its associated trajectory) in view of the autonomous platform’s interaction with the environment 100. In this manner, for example, the autonomous platform 110 may achieve at least a technical improvement that interleaves its forecasting and motion planning functionality.

To implement selected motion plan(s), the autonomy system 200 may include a control system 260 (e.g., a vehicle control system). Generally, the control system 260 may provide an interface between the autonomy system 200 and the platform control devices 212 for implementing the strategies and motion plan(s) generated by the planning system 250. For instance, the control system 260 may implement the selected motion plan/trajectory to control motion of the autonomous platform 110 through its environment 100 by following the selected trajectory (e.g., the waypoints included therein). The control system 260 may, for example, translate a motion plan into instructions for the appropriate platform control devices 212 (e.g., acceleration control, brake control, steering control). By way of example, the control system 260 may translate a selected motion plan into instructions to adjust a steering component (e.g., a steering angle) by a certain number of degrees, apply a certain magnitude of braking force, increase/decrease speed, or implement other motion controls. In some implementations, the control system 260 may communicate with the platform control devices 212 through communication channels including, for example, one or more data buses (e.g., controller area network (CAN)), onboard diagnostics connectors (e.g., OBD-II), or a combination of wired or wireless communication links. The platform control devices 212 may send or obtain data, messages, signals (or other types of communication) to or from the autonomy system 200 (or vice versa) through the communication channel(s).

The autonomy system 200 may receive, through communication interface(s) 206, assistive signal(s) from remote assistance system 270. Remote assistance system 270 may communicate with the autonomy system 200 over a network (e.g., as a remote system 160 over network 170). In some implementations, the autonomy system 200 may initiate a communication session with the remote assistance system 270. For example, the autonomy system 200 may initiate a session based on or in response to a trigger. In some implementations, the trigger may be an alert, an error signal, a map feature, a request, a location, a traffic condition, a road condition, or other trigger.

After initiating the session, the autonomy system 200 may provide context data to the remote assistance system 270. The context data may include sensor data 204 and state data of the autonomous platform. For example, the context data may include a live camera feed from a camera of the autonomous platform and a current speed of the autonomous platform 110. An operator (e.g., human operator) of the remote assistance system 270 may use the context data to select one or more assistive signals. The assistive signal(s) may provide values or adjustments for various operational parameters or characteristics for the autonomy system 200. For instance, the assistive signal(s) may include way points (e.g., a path around an obstacle, lane change), velocity or acceleration profiles (e.g., speed limits), relative motion instructions (e.g., convoy formation), operational characteristics (e.g., use of auxiliary systems, reduced energy processing modes), or other signals to assist the autonomy system 200.

The autonomy system 200 may use the assistive signal(s) for input into one or more autonomy subsystems for performing autonomy functions. For instance, the planning subsystem 250 may receive the assistive signal(s) as an input for generating a motion plan. For example, assistive signal(s) may include constraints for generating a motion plan. Additionally or alternatively, assistive signal(s) may include cost or reward adjustments for influencing motion planning by the planning subsystem 250. Additionally or alternatively, assistive signal(s) may be considered by the autonomy system 200 as suggestive inputs for consideration in addition to other received data (e.g., sensor inputs).

The autonomy system 200 may be platform agnostic, and the control system 260 may provide control instructions to platform control devices 212 for a variety of different platforms for autonomous movement (e.g., a plurality of different autonomous platforms fitted with autonomous control systems). This may include a variety of different types of autonomous vehicles (e.g., sedans, vans, SUVs, trucks, electric vehicles, combustion power vehicles) from a variety of different manufacturers/developers that operate in various different environments and, in some implementations, perform one or more vehicle services.

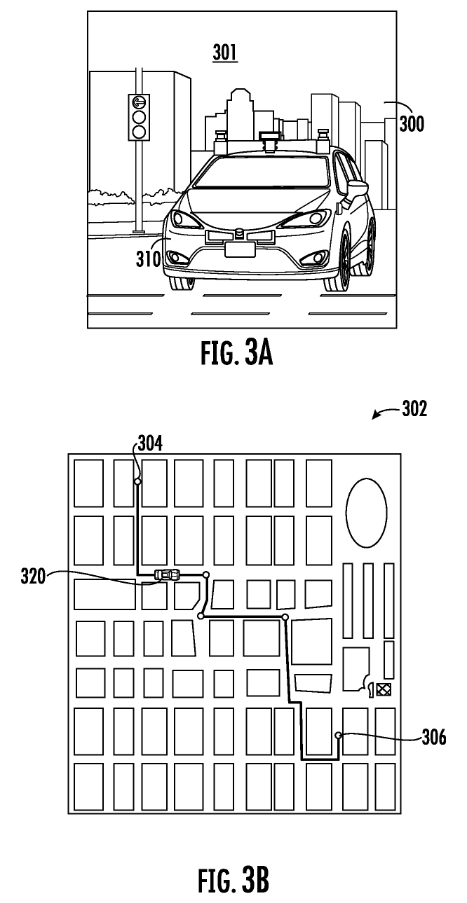

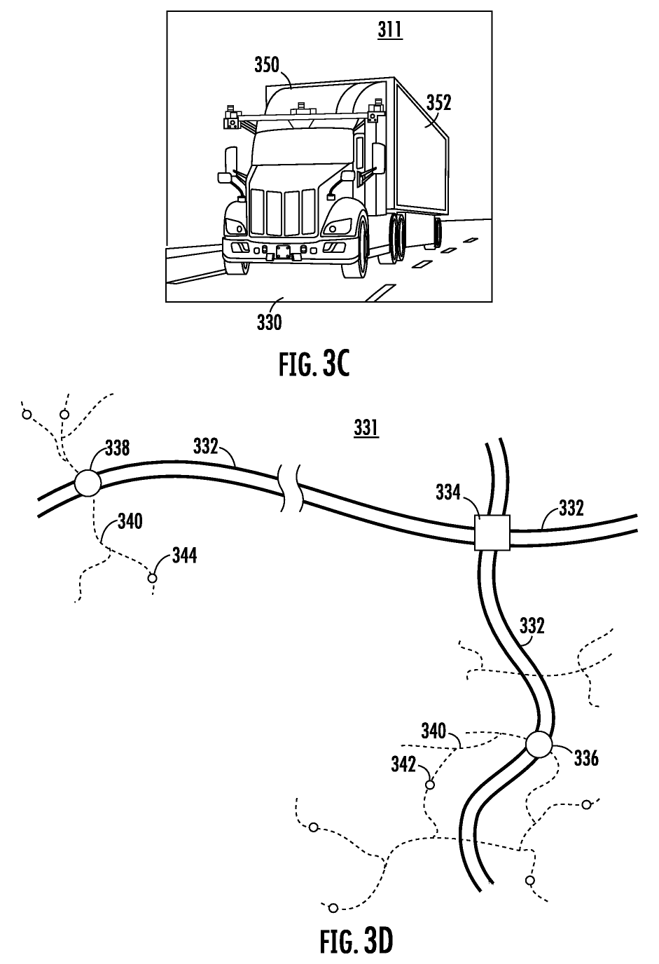

For example, with reference to FIG. 3A, an operational environment 301 may include a dense environment 300. An autonomous platform may include an autonomous vehicle 310 controlled by the autonomy system 200. In some implementations, the autonomous vehicle 310 may be configured for maneuverability in a dense environment, such as with a configured wheelbase or other specifications. In some implementations, the autonomous vehicle 310 may be configured for transporting cargo or passengers. In some implementations, the autonomous vehicle 310 may be configured to transport numerous passengers (e.g., a passenger van, a shuttle, a bus). In some implementations, the autonomous vehicle 310 may be configured to transport cargo, such as large quantities of cargo (e.g., a truck, a box van, a step van) or smaller cargo (e.g., food, personal packages).

With reference to FIG. 3B, a selected overhead view 302 of the dense environment 300 is shown overlaid with an example trip/service between a first location 304 and a second location 306. The example trip/service may be assigned, for example, to an autonomous vehicle 320 by a remote computing system. The autonomous vehicle 320 may be, for example, the same type of vehicle as autonomous vehicle 310. The example trip/service may include transporting passengers or cargo between the first location 304 and the second location 306. In some implementations, the example trip/service may include travel to or through one or more intermediate locations, such as to onload or offload passengers or cargo. In some implementations, the example trip/service may be prescheduled (e.g., for regular traversal, such as on a transportation schedule). In some implementations, the example trip/service may be on-demand (e.g., as requested by or for performing a taxi, rideshare, ride hailing, courier, delivery service).

With reference to FIG. 3C, in another example, an operational environment 311 may include an open travel way environment 330. An autonomous platform may include an autonomous vehicle 350 controlled by the autonomy system 200. This may include an autonomous tractor for an autonomous truck. In some implementations, the autonomous vehicle 350 may be configured for high payload transport (e.g., transporting freight or other cargo or passengers in quantity), such as for long distance, high payload transport. For instance, the autonomous vehicle 350 may include one or more cargo platform attachments such as a trailer 352. Although depicted as a towed attachment in FIG. 3C, in some implementations one or more cargo platforms may be integrated into (e.g., attached to the chassis of) the autonomous vehicle 350 (e.g., as in a box van, step van).

With reference to FIG. 3D, a selected overhead view 331 of open travel way environment 330 is shown, including travel ways 332, an interchange 334, transfer hubs 336 and 338, access travel ways 340, and locations 342 and 344. In some implementations, an autonomous vehicle (e.g., the autonomous vehicle 310 or the autonomous vehicle 350) may be assigned an example trip/service to traverse the one or more travel ways 332 (optionally connected by the interchange 334) to transport cargo between the transfer hub 336 and the transfer hub 338. For instance, in some implementations, the example trip/service includes a cargo delivery/transport service, such as a freight delivery/transport service. The example trip/service may be assigned by a remote computing system. In some implementations, the transfer hub 336 may be an origin point for cargo (e.g., a depot, a warehouse, a facility) and the transfer hub 338 may be a destination point for cargo (e.g., a retailer). However, in some implementations, the transfer hub 336 may be an intermediate point along a cargo item’s ultimate journey between its respective origin and its respective destination. For instance, a cargo item’s origin may be situated along the access travel ways 340 at the location 342. The cargo item may accordingly be transported to the transfer hub 336 (e.g., by a human-driven vehicle, by the autonomous vehicle 310) for staging. At the transfer hub 336, various cargo items may be grouped or staged for longer distance transport over the travel ways 332.

In some implementations of an example trip/service, a group of staged cargo items may be loaded onto an autonomous vehicle (e.g., the autonomous vehicle 350) for transport to one or more other transfer hubs, such as the transfer hub 338. For instance, although not depicted, it is to be understood that the open travel way environment 330 may include more transfer hubs than the transfer hubs 336 and 338, and may include more travel ways 332 interconnected by more interchanges 334. A simplified map is presented here for purposes of clarity only. In some implementations, one or more cargo items transported to the transfer hub 338 may be distributed to one or more local destinations (e.g., by a human-driven vehicle, by the autonomous vehicle 310), such as along the access travel ways 340 to the location 344. In some implementations, the example trip/service may be prescheduled (e.g., for regular traversal, such as on a transportation schedule). In some implementations, the example trip/service may be on-demand (e.g., as requested by or for performing a chartered passenger transport or freight delivery service).

To help improve the performance of an autonomous platform, such as an autonomous vehicle controlled at least in part using autonomy system(s) 200 (e.g., the autonomous vehicles 310 or 350), the perception system 240 may detect the shapes and extensions of objects according to example aspects of the present disclosure.

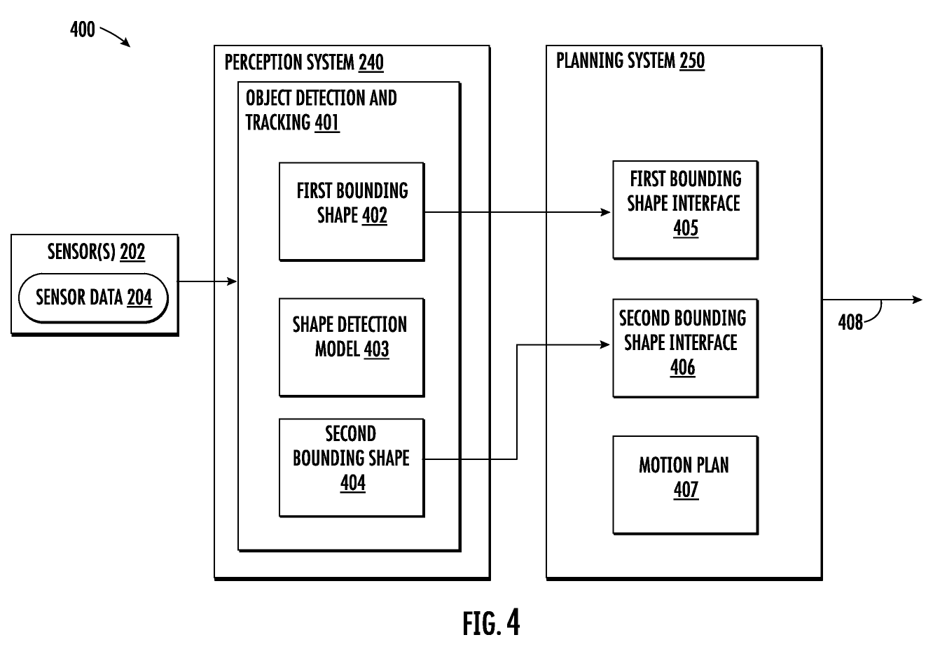

FIG. 4 is a block diagram 400 including an object detection and tracking system 401 (also referred to as “detection and tracking system 401”), according to some implementations of the present disclosure. The detection and tracking system 401 may be included, for example within the perception system 240 of an autonomous vehicle. Although FIG. 4 illustrates an example implementation of a detection and tracking system 401 having various components, it is to be understood that the components may be rearranged, combined, supplemented, or omitted, within the scope of and consistent with the present disclosure.

To help detect objects and their extensions, the detection and tracking system 401 may obtain sensor data 204. As described herein, the sensor data 204 may include data captured through one or more sensors 202 onboard an autonomous vehicle. This may include RADAR data, LIDAR data, image data, or other types of data. For example, the sensor data 204 may include image frames captured during instances of real-world driving, and associated times in which the objects in the environment were perceived. The sensor data 204 may include data collected from other sources (e.g. roadside cameras, aerial vehicles, other vehicles).

The sensor data 204 may be associated with a plurality of times. By way of example, the sensor data 204 may include a plurality of image frames indicative of an actor in an environment of the autonomous vehicle. Each respective image frame may be associated with a time/time stamp at which the image frame was captured. For instance, the plurality of image frames may include a sequence of image frames taken across a plurality of times and depicting an object in the environment.

As described herein, the object may include actor. The actor may include another vehicle. The vehicle may include, for example, a sedan, a truck, tractor, or another type of automobile. The environment may be, for example, the environment outside of and surrounding the autonomous vehicle (e.g., within a sensor field of view). In some implementations, the sensor data 204 may include video data. Additionally, or alternatively, the sensor data 204 may include multiple single, static images.

In another example, the sensor data 204 may include point cloud data (e.g., three-dimensional LIDAR point cloud data, RADAR point cloud data). By way of example, the sensor data 204 may include a point cloud depicting an actor in the surrounding environment of the autonomous vehicle. The point cloud data may be generated through one or more LIDAR sweeps (e.g., rotational sensor(s)) that capture depth information at a time/time stamp at which the object was perceived.

The sensor data 204 (e.g., point cloud data, image data) may also depict extensions of objects in the surrounding environment. For instance, sensor data 204 including point cloud data may depict the object as a collection of LIDAR points representing the main volume of the actor and include extensions (e.g., mirrors, cargo, vehicle add-ons) depicted as a collection of LIDAR points that extend from the main volume of LIDAR points. The sensor data 204 may depict the full shape of objects in the environment.

The detection and tracking system 401 may subscribe to sensor data 204 such as LIDAR, RADAR, and camera data to generate track data. Track data may include state data and a bounding shape of the object. State data may include the position, velocity, acceleration or other characteristics of an object at the time at which the object was perceived, at one or more times. The track data may provide updates, and validity estimates for all detected and tracked objects to the planning system 250, such that a motion plan 407 (e.g., motion trajectory) may be computed that navigates the autonomous vehicle relative to the object (e.g., around the actor).

By way of example, at each frame the detection and tracking system 401 may associate sensor data 204 (e.g., LIDAR, RADAR, image data) to relevant tracks. The LIDAR and RADAR points may be transformed into the proximate frame of each track. An image crop for each track may be generated by projecting the oriented bounding shape (e.g., 2D or 3D bounding box) of the track into the camera image. The data associated with each track is then transformed into input features for a neural network. This neural network may output an estimated state adjustment for each track and a validity estimate that corresponds to the confidence of the perception system 240 that a given track should be reported to the planning system 250.

The detection and tracking system 401 may, based on the shape detection model 403, generate the bounding shapes included in the track data. The shape detection model 403 (e.g., a machine-learned model) may analyze the sensor data 204 indicating an object and efficiently detect the object and any extensions. For instance, the shape detection model 403 may determine a first bounding shape 402 that represents a canonical shape (e.g., boundary) of the object depicted in the sensor data 204 and a second bounding shape 404 that accounts for extensions of the object that extend outside the first bounding shape 402. Extensions may include a protrusion of an item being transported by the object (including an attachment thereto, e.g., a trailer), or a protrusion of a component of the object itself.

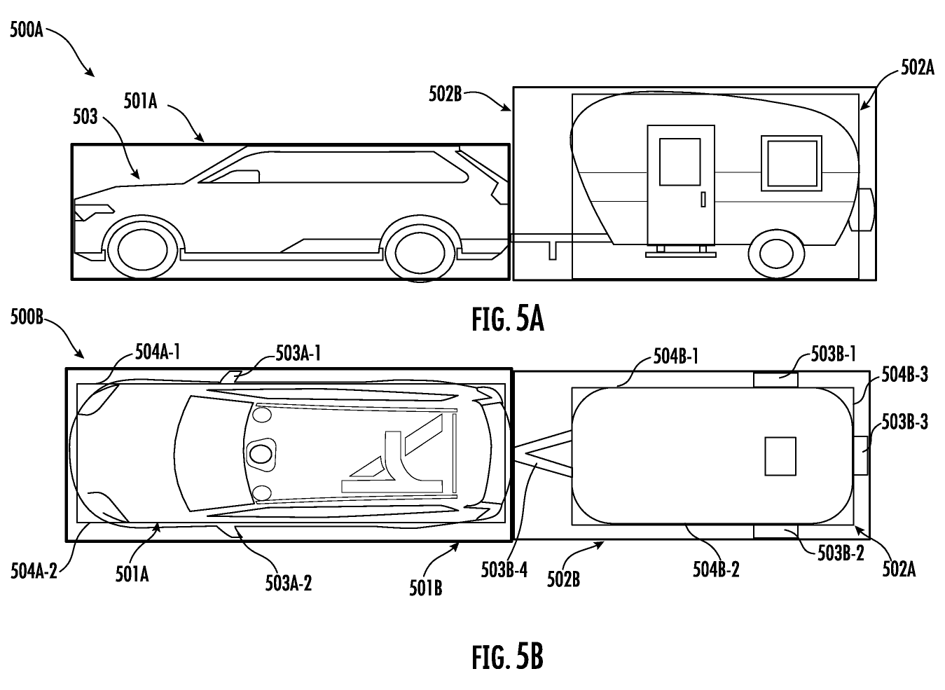

A bounding shape may be any shape (e.g., a polygon) that includes an object depicted in sensor data. For example, as shown in diagrams 500A-B of FIGS. 5A-B, the bounding shapes 501A-B, 502A-B may include three-dimensional rectangular bounding boxes that enclose the respective portions of an object 503: a vehicle (e.g., tractor) and a trailer attached thereto. FIG. 5A depicts a side view and FIG. 5B depicts an overhead bird’s eye view (BEV) of the bounding shapes 501A-B, 502A-B and the object 503. While FIGS. 5A-B depicts rectangular bounding shapes, one of ordinary skill in the art will understand that other shapes may be used such as circles, squares, or other types of shapes. Moreover, bounding shapes may be two-dimensional, three-dimensional, or other multi-dimensional shapes.

As described herein, the autonomous vehicle may identify the object 503 as a single object (e.g., vehicle with attachment combination) with multiple portions and generate respective bounding shapes 501A-B, 502A-B for the respective portions. Additionally, or alternatively, the autonomous vehicle may identify the vehicle as a first object and generate the bounding shapes 501A-B for the vehicle. The autonomous vehicle may identify the trailer has a second object and generate the bounding shapes 502A-B for the trailer. Metadata may link the two objects to indicate the dependency between them (e.g., the motion of the trailer corresponding to the motion of the vehicle).

In some implementations, the bounding shapes 501A-B, 502A-B may be generated on a per pixel level. In some implementations, the track data may include the x, y, z coordinates of the boundaries and center of the respective bounding shapes 501A-B, 502A-B, as well as the length width and height of the respective bounding shapes 501A-B, 502A-B. In some examples, the track’s state may fit a multivariate normal distribution.

The bounding shapes 501A, 502A may include a shape that matches the boundaries/perimeter of the canonical shape of the object 503. The canonical shape may represent the standard form/shape for the type of object. An object type may describe the classification of the object including, for example, a vehicle, a pedestrian, a bicycle, a trailer, or other categories. In some implementations, classifications may include sub-categories. For example, a vehicle classification may include a truck classification, a sedan classification, a construction vehicle classification, or other automobile-related classification. In some implementations, a bounding shape may correspond to the contours of the boundaries of the object 503.

Returning to FIG. 4, an object may, at times, include extensions that extend beyond the contours of those boundaries creating complexities in training the shape detection model 403 to consistently detect these extensions. To address this technical problem, the shape detection model 403 may generate a first bounding shape 402 (e.g., canonical shape) enclosing the main area/volume of the object and generate a second bounding shape 404 enclosing extensions that extend outside the first bounding shape 402. By generating the first bounding shape 402 and the second bounding shape 404, the shape detection model 403 may more efficiently be trained to detect both the main volume/area of objects and their extensions, while preserving computing resources when there are no extensions that extend outside (e.g., beyond) the first bounding shape 402.

The shape detection model 403 may include one or more machine-learned models trained to generate the first bounding shape 402 and the second bounding shape 404. The shape detection model 403 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The shape detection model 403 may be trained through the use of one or more model trainers and training data. The model trainers may be trained using one or more training or learning algorithms. One example training technique is backwards propagation of errors. In some examples, simulations may be implemented for obtaining the training data or for implementing a model trainer for training or testing the model. In some examples, a model trainer may perform supervised training techniques using labeled training data. As further described herein, the training data may include labeled image frames that have labels indicating the canonical shape and the observed shape (e.g., including the object extensions) of a training object. In some examples, the training data may include simulated training data (e.g., training data obtained from simulated scenarios, inputs, configurations, environments).

Additionally, or alternatively, a model trainer may perform unsupervised training techniques using unlabeled training data. By way of example, a model trainer may train one or more components of a machine-learned model to perform object detection through unsupervised training techniques using an objective function (e.g., costs, rewards, heuristics, constraints). In some implementations, a model trainer may perform a number of generalization techniques to improve the generalization capability of the model(s) being trained. Generalization techniques include weight decays, dropouts, or other techniques.

The shape detection model 403 may process the sensor data 204 and generate the first bounding shape 402 that corresponds to the shape of the object. The first bounding shape 402 may correspond to the shape of the object by representing a canonical shape fit tightly to the main area/volume of the detected object. For instance, the shape detection model 403 may be a trained convolutional neural network configured to analyze image sensor data and divide the image data into regions of interest to extract features from these regions. The extracted features may then be used to classify an object (e.g., vehicle, pedestrian) and generate the first bounding shape 402.

The shape detection model 403 may generate the first bounding shape 402 based on a classification of the object. By way of example, the extracted features may classify the object depicted in the image as a vehicle and the shape detection model 403 may generate a default vehicle label associated with a bounding shape (e.g., first bounding shape 402) to enclose the vehicle. In another example, the object may be classified as a truck, with a tractor portion pulling an attachment (e.g., a trailer). In response, the shape detection model 403 may generate a first bounding shape 402 that includes a bounding shape for the tractor and another bounding shape for the trailer.

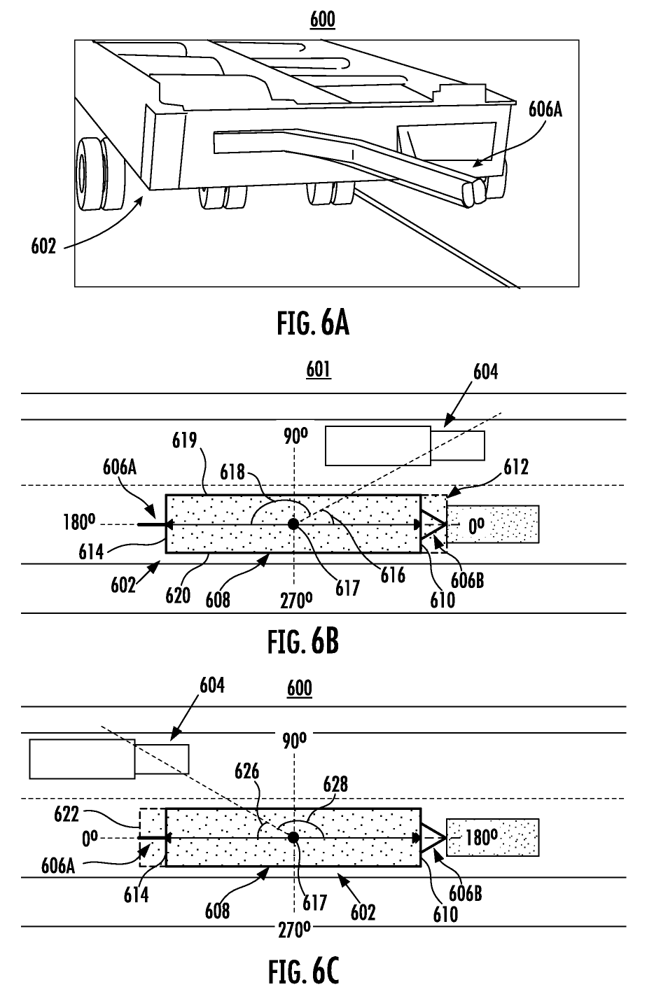

Additionally, or alternatively, the shape detection model 403 may analyze point cloud sensor data and implement a sensory fusion approach that combines LIDAR point clouds with RGB color values to generate accurate 3D positioning of the first bounding shape 402 that represents the detected object. For instance, a matching network may combine spatial (e.g., LIDAR) and appearance (e.g., RGB color value) information. The shape detection model 403 may create a 3D bounding box (e.g., first bounding shape 402) using dense encodings of point clouds (e.g., front or birds-eye views). An example of detecting an object in point cloud sensor data is further described with reference to FIGS. 6B-C.

One of ordinary skill in the art will understand that various types of algorithm or deep learning model designed to analyze images, LIDAR, or video frames to detect objects and generate bounding shapes may be used to generate the first bounding shape 402. In an implementation, the first bounding shape 402 may be generated by another system and processed by the shape detection model 403 to generate the second bounding shape 404.

The shape detection model 403 may determine, based on the sensor data 204 and the first bounding shape 402, the existence of an extension of the object outside the boundary corresponding to the shape of the object (e.g., represented by the first bounding shape 402). For example, with reference to FIGS. 5A-B, a canonical shape of the vehicle may be represented by a first vehicle bounding shape 501A. The first vehicle bounding shape 501A may correspond to the shape of the vehicle shown in FIGS. 5A-B, by encapsulating the main volume/area of a vehicle. The first trailer bounding shape 502A may correspond to the shape of the trailer shown in FIGS. 5A-B, by encapsulating the main volume/area of a trailer and representing the canonical shape of the trailer.

The shape detection model 403 may analyze the sensor data 204 and the bounding shapes 501A, 502A to identify extensions 503A-1, 503A-2, and 503B1-4 of the vehicle or trailer that extend outside the boundaries of the first vehicle bounding shape 501A or the first trailer bounding shape 502A. For example, the first vehicle bounding shape 501A (e.g., representing canonical shape of the vehicle) does not include the extensions 503A-1, 503A-2 - the left and right side mirrors of the vehicle that extend outside the boundaries of the first vehicle bounding shape 501A. Similarly, the first trailer bounding shape 502A (e.g., representing the canonical shape of the trailer) does not include the entire extensions 503B1-4 (e.g., functional wheels, spare wheels, or trailer hitch), in that at least a portion of these components of the trailer extend outside the boundaries of the first trailer bounding shape 502A.

To identify the existence of these extensions, the shape detection model 403 may analyze various types of data. For example, the shape detection model 403 may process image pixels of the sensor data 204 and determine that certain pixels (e.g., indicating a component of the vehicle or trailer) appear to extend from the object and are present outside the boundaries of the first vehicle bounding shape 501A. Additionally, or alternatively, the shape detection model 403 may analyze a LIDAR point cloud of the sensor data 204 and determine that a certain density of LIDAR points exist for a structure that extends outside first vehicle bounding shape 501A.

With reference again to FIG. 4, the shape detection model 403 may generate, based on the first bounding shape 402, the second bounding shape 404 including the extensions of the vehicle and trailer. For instance, the second bounding shape 404 may enclose the main volume of the vehicle and trailer (including any extensions) in an interior region defined by the second bounding shape 404.

The shape detection model 403 may determine, based on the extension, a first portion of the first bounding shape 402 at which the extension is located. For instance, the shape detection model 403 may analyze the sensor data 204 including the first bounding shape 402 to determine which side(s) or portion(s) of the first bounding shape 402 includes an extension. The shape detection model 403 may detect an extension by analyzing pixels in an image that connect to the detected object (e.g., within the first bounding shape 402) and extend outside the first bounding shape 402 on a particular side or portion of the first bounding shape 402. Additionally, or alternatively, the shape detection model 403 may detect an extension by detecting a collection of LIDAR points that extend beyond the main volume of LIDAR points that represent the detected object (e.g., within the first bounding shape 402) on a particular side or portion of the first bounding shape 402.

By way of example, as shown in FIGS. 5A-B, the extensions 503A-1 and 503A-2 (e.g., mirrors) of the vehicle extend outside the boundaries of first vehicle bounding shape 501A. With reference to the BEV view of FIG. 5B, the shape detection model 403 may analyze the BEV image data (e.g., pixel analysis) indicative of the vehicle and determine a first extension 503A-1 is located outside a first side 504A-1 and a second extension 503A-2 is located outside a second side 504A-2 of the first vehicle bounding shape 501A. The shape detection model 403 may analyze the BEV image data indicative of the trailer and determine the extensions 503B-1, 503B-2, and 503B-3 (e.g., wheels and spare wheel) are located outside a first side 504B-1, a second side 504B-2, and a third side 504B-3, respectively, of the first trailer bounding shape 502A.

In some implementations, the shape detection model 403 may analyze sensor data 204 from multiple points of view to determine the existence of extensions. This may include, for example, analyzing image or LIDAR data from a BEV standpoint (e.g., as in FIG. 5B) and from a side vantage point (e.g., as in FIG. 5A). Analyzing sensor data 204 from multiple points of view may allow the shape detection model 403 to identify extensions that appear in one point of view, but not another (e.g., extensions 503A-1, 503A-2).

In response to determining the location of the extensions with respect to the first bounding shapes 501A, 502A, the shape detection model 403 may perform a transformation on a first bounding shape 501A, 502A. A transformation may include shifting a boundary (e.g., portion, side) away from the centroid of the first bounding shape 501A, 502A or otherwise deforming the first bounding shape 501A, 502A to enclose the extension. A second bounding shape 501B, 502B may be or otherwise include a transformed version of a first bounding shape 501A, 502A.

For example, the shape detection model 403 may determine an extension 503A-1 is located at the first side 504A-1 of the first vehicle bounding shape 501A and transform the first side 504A-1 by shifting the first side 504A-1 away from (e.g., upwards in FIG. 5B) the centroid of the first vehicle bounding 501A until the entirety of the extension 503A-1 (e.g., including the mirror’s outermost surface from the centroid) is encapsulated within the interior region of the bounding shape. The shape detection model 403 may similarly transform the second side 504A-2 of the first vehicle bounding shape 501A, to encapsulate the extension 503A-2 (e.g., left mirror) located at the second side 504A-2.

The shape detection model 403 may generate the second vehicle bounding shape 501B based on the transformation of the first vehicle bounding shape 501A. For example, the second vehicle bounding shape 501B may include the first side 504A-1 that has been transformed, such that an outer surface of the extension 503A-1 (e.g., right mirror) is included in the interior region of the second vehicle bounding shape 501B. As such, the second vehicle bounding shape 501B (e.g., depicting the observed shape) may include a larger volume/area than the first vehicle bounding shape 501A (e.g., depicting the canonical shape).

While examples herein describe the process of generating the second vehicle bounding shape 501A in a particular sequence, the present disclosure is not limited to such embodiment and steps may additionally or alternatively be performed concurrently.

Returning to FIG. 4, in some implementations, the shape detection model 403 may determine which portions of a first bounding shape 402 are relevant to the autonomous vehicle. The shape detection model 403 may transform the relevant portions to generate the second bounding shape 404. To identify the relevant portions, the shape detection model 403 may be structured to weigh one or more factors. Example factors may include the visibility of the portion to the autonomous vehicle, an angle between the autonomous vehicle and the object, a distance between the autonomous vehicle and the object, or other factors.

For instance, with reference to FIGS. 6A-C, an object 602 may be located within an environment 600 of an autonomous vehicle 604 (e.g., an autonomous truck). The object 602 may include a trailer that is being pulled by a vehicle (e.g., a tractor). The trailer may include a first component 606A that protrudes from the rear/stern of the trailer. The first component 606A may include, for example, a connection mechanism or locking mechanism for securing a load to the trailer. The trailer may include a second component 606B (shown in FIG. 6B) that protrudes from the front/bow of the trailer. The second component 606B may include, for example, a trailer hitch to connect the trailer to a vehicle for pulling the trailer. A first bounding shape 608 may be generated for the object 602 according to the techniques described herein.

FIG. 6B is a diagram 601 depicting an overview view of the autonomous vehicle 604 at a first position relative to the object 602. At the first position, the autonomous vehicle 604 may be located diagonally on the front, left side of the object 602. The shape detection model 403 may determine that a first portion 610 of the first bounding shape 608 (e.g., corresponding to the front of the trailer) is within a field of view of a sensor of the autonomous vehicle 604. Thus, the shape detection model 403 may consider the first portion 610 relevant to the autonomous vehicle 604 because it is within the sensor field of view. The shape detection model 403 may determine that an extension exists relative to the first portion 610 based on the second component 606B and transform the first portion 610. The transformation of the first portion 610 may be used to generate a second bounding shape 612 that encompasses the trailer and the extension created by the first component 606B.

Additionally, or alternatively, the shape detection model 403 may determine which portions of a first bounding shape 608 to transform based on an angle between the autonomous vehicle 604 and the first bounding shape 608. To do so, the shape detection model 403 may determine a first angle 616 between the autonomous vehicle 604 and a centroid 617 of the first bounding shape 608 of the object 602 within a local frame. The local frame for the object 602 may be defined/oriented based on the first bounding shape 608 and its respective portions (e.g., sides). By way of example, the local frame may include an axis extending from the centroid 617 to the first portion 610 (e.g., for the front of the trailer), representing 0 degrees and an axis extending from the centroid 617 to the second portion 614 (e.g., for the back of the trailer) representing 180 degrees. An axis extending from the centroid 617 to a third portion 619 of the first bounding shape 608 (e.g., for the left side of the trailer), may represent 90 degrees within the local frame. An axis extending from the centroid 617 to a fourth portion 620 of the first bounding shape 608 (e.g., for the right side of the trailer), may represent 270 degrees within the local frame. The shape detection model 403 may determine that the first angle 616 between the autonomous vehicle 604 and axis extending through the first portion 610 is forty-five degrees, with respect to the local frame. The first angle 616 may correspond to an angle of visibility of the first portion 610, for the autonomous vehicle 604.

The shape detection model 403 may determine that a second angle 618 between the autonomous vehicle 604 and the axis extending through the second portion 614 is one hundred, thirty-five degrees, with respect to the local frame. The second angle 618 may correspond to an angle of visibility of the second portion 614.

In some implementations, the shape detection model 403 may perform the described angle computations in parallel for all sides of the bounding shape 608 of the object 602. For instance, the first angle 616 or the second angle 618 may be used as input into the shape detection model 403. The shape detection model 403 may output a Boolean value (e.g., visible or not visible) for each side of the first bounding shape 608 indicating whether an angle of visibility is present.

The shape detection model 403 may compare these angles to an angle threshold. For example, the shape detection model 403 may generate a comparison of the first angle 616 to the angle threshold. The angle threshold may help indicate angles where insufficient sensor data 204 is available (e.g., due to the angle) to depict an extension. In other examples, the angle threshold may include the angular size (e.g., the amount of space an object takes up in the field of view in degrees, minutes, seconds).

The angle threshold may indicate an upper bound. Angles determined to be at or below the upper bound may indicate that the autonomous vehicle 604 has sufficient visibility of the corresponding portion of the object 602. The angle threshold may range from one hundred to one hundred, fifteen degrees. Angles that satisfy such an angle threshold, may be considered relevant to the autonomous vehicle 604 and identified for transformation to include any existing extensions. Angles above the upper bound may indicate that the corresponding portion of the first bounding shape 608 may have a minimal effect on the motion planning of the autonomous vehicle 604, given the position of the autonomous vehicle 604 relative to the object 602.

For example, the angle threshold may be one hundred, ten degrees. The shape detection model 403 may compare the first angle 616 (e.g., 45 degrees) to the angle threshold. The shape detection model 403 may determine that the first angle 616 is less than the angle threshold. The shape detection model 403 may compare the second angle 618 (e.g., 135 degrees) to the angle threshold. The shape detection model 403 may determine that the second angle 618 is greater than the angle threshold.

Based on the comparison of an angle to the angle threshold, the shape detection model 403 may generate the second bounding shape 612 based on the first bounding shape 608. For instance, the shape detection model 403 may determine that the comparison of the first angle 616 to the angle threshold indicates that the first angle 616 is less than the angle threshold and transform the first portion 610 of the first bounding shape 402 to enclose the depicted extension of second component 606B (e.g. the trailer hitch), as shown in FIG. 6B. The transformation may include shifting the first portion 610 away from the centroid 617 of the first bounding shape 608 until the entire extension is enclosed in the interior region of the bounding shape. The shape detection model 403 may determine that the second portion 614 of the first bounding shape 608 is not to be transformed because the second angle 618 is greater than the angle threshold, indicating its lower visibility for (and lower effect on) the autonomous vehicle 604.

In some implementations, the angle threshold may indicate a lower bound. Angles determined to be at or above the lower bound may indicate that the autonomous vehicle 604 has sufficient visibility of the corresponding portion of the object 602. Angles at or above such an angle threshold, may be considered relevant to the autonomous vehicle 604 and identified for transformation to including any existing extensions.

In some implementations, the shape detection model 403 may parameterize the computations by the angle threshold during training. For instance, the visibility threshold may be tuned based on real-world observations of when the object 602 is visible within a field of view of a sensor 202 of the autonomous vehicle 604. To do so, a wider visibility threshold can be used to train the shape detection model 403 to predict the visibility threshold and a narrower visibility threshold can be used during operations for real-time predictions. In an embodiment, heuristics may be used to determine the visibility threshold for sides of objects 602. For instance, engineered heuristics may be used to determine when a side includes a threshold number of lidar points to be visible.

In other implementations, the shape detection model 403 may not utilize a visibility threshold. For instance, the shape detection model 403 may output the second bounding shape 612 (e.g., depicting the observed shape) irrespective of the visibility angle. To do so, the shape detection model 403 may be trained to predict sides that are not visible. By way of example, the shape detection model 403 may predict a mirror protrusion on a “far” side of the object 602, based on a mirror protrusion on the “near” visible side irrespective of the angle of visibility for the “far” side. Accordingly, the shape detection model 403 may output the second bounding shape 612 which accounts for the visible protrusion and an invisible protrusion.

The shape detection model 403 may be structured to iteratively determine the relevancy of portions of the first bounding shape 608 as the relative position of the autonomous vehicle 604 and the object 602 changes. For example, FIG. 6C depicts the autonomous vehicle 604 at a second position relative to the object 602 (e.g., at a subsequent time step from the depiction in FIG. 6B). At the second position, the autonomous vehicle 604 may be located diagonally on the rear, left side of the object 602. The shape detection model 403 may determine that the second portion 614 of the first bounding shape 608 (e.g., corresponding to the rear of the trailer) is now within a field of view of a sensor of the autonomous vehicle 604. The shape detection model 403 may determine that the first portion 610 of the first bounding shape 608 (e.g., corresponding to the front of the trailer) is no longer within a field of view of a sensor of the autonomous vehicle 604. Thus, the shape detection model 403 may determine that the second portion 614 is relevant to the autonomous vehicle and the first portion 610 is no longer relevant to the autonomous vehicle 604. Accordingly, the shape detection model 403 may generate an updated second bounding shape 622 by transforming the second portion 614 to encompass the extension created by the first component 606A within the interior region of the bounding shape. The updated second bounding shape 622 may not encompass the extension created by the second component 606B because the corresponding first portion 610, is no longer considered relevant to the autonomous vehicle 604.

Additionally, or alternatively, the shape detection model 403 may be structured to iteratively update its angular analysis. For example, given the second position of the autonomous vehicle 604 depicted in FIG. 6C, the local frame may be updated such that the local frame includes an axis extending from the centroid 617 to the second portion 614 (e.g., for the rear of the trailer) representing 0 degrees and an axis extending from the centroid 617 to the first portion 610 (e.g., for the front of the trailer) representing 180 degrees. A first angle 626 between the axis extending to the second portion 614 and the autonomous vehicle 604 may be forty-five degrees. A second angle 628 between the axis extending to the first portion 610 and the autonomous vehicle 604 may be one hundred, thirty-five degrees.

A comparison of the first angle 626 to an angle threshold (e.g., 110 degrees) may indicate that the second portion 614 is relevant to the autonomous vehicle 604 in the second position (at the related time frame). A comparison of the second angle 628 to an angle threshold (e.g., 110 degrees) may indicate that the first portion 610 is not relevant to the autonomous vehicle 604 in the second position (at the related time frame).

The shape detection model 403 may generate the updated second bounding shape 622 based on the comparison(s). For example, the updated second bounding shape 622 may be generated by shifting the second portion 614 away from the centroid 617 until the entire extension created by the first component 606A is enclosed within the interior region of the bounding shape. The shape detection model 403 may forgo transforming the first portion 610 or revert the first portion 610 back to a position aligned with the first bounding shape 608, such that the extension created by the second component 606B is not enclosed in the interior region of the updated second bounding shape 622.

In some implementations, the shape detection model 403 may filter its analysis based on a distance between the autonomous vehicle 604 and the object 602. For example, the shape detection model 403 may determine a distance between the autonomous vehicle 604 and the object 602 and compare the distance to a distance threshold (e.g., 80-150m). In the event that the distance is less than or equal to the distance threshold (e.g., 100m), the shape detection model 403 may analyze the object 602 for extensions and generate second bounding shapes, as described herein. In the event that the distance is greater than the distance threshold, the shape detection model 403 may forgo analyzing the object 602 for extensions and forgo generating second bounding shapes associated therewith. This may allow the autonomous vehicle 604 to save its onboard computing resources to analyze objects that are of higher relevance to the motion planning of the autonomous vehicle 604.

Returning to FIG. 4, the object detection and tracking system 401 may output track data to the planning system 250. The track data may be indicative of the first bounding shape 402 and the second bounding shape 404. In some implementations, the track data may be indicative of the second bounding shape 404, without propagating the first bounding shape 402 further downstream in the autonomy pipeline.

The planning system 250 may include a first bounding shape interface 405 and a second bounding shape interface 406 structured to consume tracks including the first bounding shape 402 and the second bounding shape 404, respectively. The first bounding shape interface 405 and the second bounding shape interface 406 may include software programed to receive and process track data.

The track data including second bounding shape 404 may be consumed by the second bounding shape interface 406 and used by the planning system 250 to generate a motion plan 407 that accounts for the detected object (e.g., including any extensions) in the surrounding environment of the autonomous vehicle. For instance, the motion plan 407 may include one or more parameters to control the motion of the autonomous vehicle to avoid the object, as further described herein.

The first bounding shape 402 and the second bounding shape 404 may be provided to the planning system 250 in an asynchronous manner. For instance, the detection and tracking system 401 may provide data indicative of the first bounding shape 402 to the planning system 250 at a first time and data indicative of the second bounding shape 404 to the planning system 250 at a second time that is subsequent to the first time. This may allow the planning system 250 to perform a computation based on the first bounding shape 402, without having to wait until the second bounding shape 404 is generated.

The motion plan 407 may still be considered to be generated based on the second bounding shape 404 even if the trajectory for the autonomous vehicle ultimately does not explicitly account for moving the autonomous vehicle based on the second bounding shape 404 in a given timeframe. For example, the planning system 250 may determine that the autonomous vehicle is to pull over to the left shoulder of a roadway, moving the autonomous vehicle away from the object. While the planning system 250 may have weighed, costed, or otherwise considered the second bounding shape 404 when generating the trajectory, other circumstances may have been afforded a higher weight (e.g., an obstacle in a current lane) leading to a trajectory with waypoints that do not explicitly travel around the object. Thus, in some implementations, a motion plan 407 or trajectory may still be considered to have been generated based on the second bounding shape 404 so long as the motion planning system 250 processed the second bounding shape 404.

In some implementations, the planning system 250 may utilize the first bounding shape 402 to generate a motion plan 407 for the autonomous vehicle. For instance, the planning system 250 may consume, via the first bounding shape interface 405, the first bounding shape 402 of a detected object. The first bounding shape 402 may include labels that indicate the type of object, track data and a position of the object relative to the autonomous vehicle.

The planning system 250 may determine, based on the first bounding shape 402, an estimated position of the object within a roadway. For instance, sensor data 204 that depicts an object a substantial distance in front of the autonomous vehicle may include sufficient information to determine that the object is positioned in an adjacent lane and generate a motion plan to avoid interfering with the object even without context of extensions (e.g., second bounding shape 404.), given the longer distance/timing.

The planning system 250 may generate, based on the estimated position of the object within the roadway, the motion plan 407 for the autonomous vehicle. For instance, the planning system 250 may generate a motion plan 407 that continues the path of the autonomous vehicle in its current lane.

The planning system 250 may provide one or more instructions 408, to the control system 260, to control the motion of the autonomous vehicle in accordance with the one or more parameters of the motion plan 407. The parameters may be indicative of a trajectory (e.g., with way point coordinates), vehicle heading/steering angle, acceleration, speed, accelerator/braking force, or other parameters that may be translated by the control system 260 to control the motion of the autonomous vehicle.

The instructions may include data, encoded signals, messages, or other forms of communication. The instructions may control the motion of the autonomous vehicle based on the position of the extensions relative to the autonomous vehicle. For example, the instructions may be implemented to adjust the motion of the autonomous vehicle to: change lanes, pull over (e.g., to avoid the extensions), provide more distance between the autonomous vehicle and the extensions of the detected object, allow the extension of the object to pass, or other actions.

The motion planning system 250 may provide data indicative of the trajectory that was generated based on the detection of the extensions, predicted reactions from other object to avoid the extensions, or other environmental factors. The control system 260 may control the autonomous vehicle’s maneuvers based on the trajectory or other parameters.

In some examples, the motion planning system 250 may take into account the extensions in its trajectory generation and determine that the autonomous vehicle does not need to change acceleration, velocity, or heading because the autonomous vehicle is already appropriately positioned with respect to the extensions of the object. This may include a scenario when the extensions are already sufficiently positioned ahead of the autonomous vehicle. As such, the motion plan 407 may still be considered to be generated based on the second bounding shape 404.

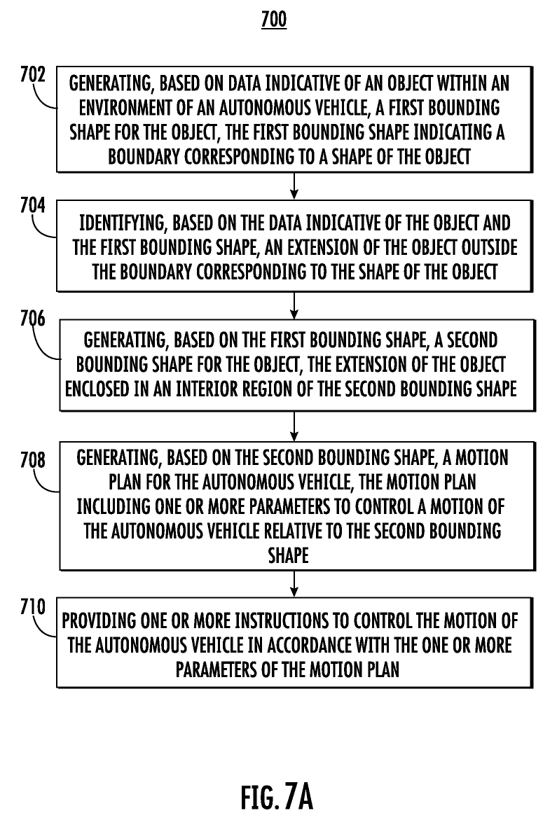

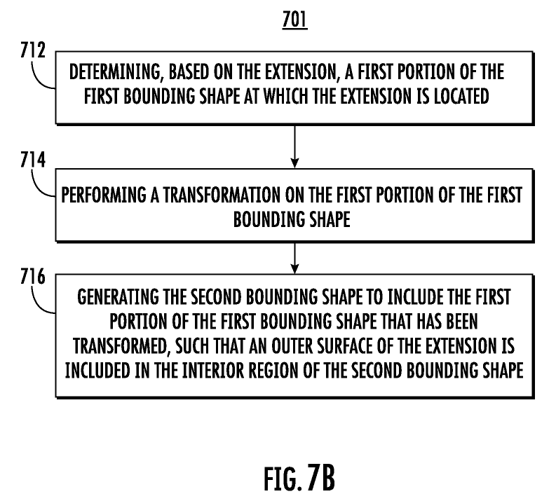

FIGS. 7A-10 are flowcharts of example methods, according to some implementations of the present disclosure. One or more portion(s) of the described methods may be implemented by a computing system that includes one or more computing devices such as, for example, the computing systems described with reference to the other figures(e.g., autonomous platform 110, vehicle computing system 180, remote system(s) 160, a system of FIG. 4, a system of FIG. 12). Each respective portion of the method 700 may be performed by any (or any combination) of one or more computing devices. Moreover, one or more portion(s) of the method 700 may be implemented on the hardware components of the device(s) described herein (e.g., as in FIGS. 1, 2, 4, 12), for example, to generate bounding shapes, control a vehicle, generate training data, or train a model.

FIGS. 7A-10 depict elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIGS. 7A-11 are described with reference to elements/terms described with respect to other systems and figures for exemplary illustrated purposes and is not meant to be limiting. One or more portions of the described methods may be performed additionally, or alternatively, by other systems.

At 702, the method 700 may include generating, based on data indicative of an object within an environment of an autonomous vehicle, a first bounding shape 402 for the object, the first bounding shape 402 indicating a boundary corresponding to a shape of the object. For instance, an autonomous vehicle may process data (e.g., sensor data 204) indicative of an object within the environment of the autonomous vehicle. The object may be another vehicle (e.g., a pick-up truck) travelling in the same or nearby lane of the autonomous vehicle within a highway environment.

The method 700 may include determining, based on the data indicative of the object, that the object is not an ephemeral object. For example, the autonomous vehicle may filter out ephemeral objects/tracks from its dual-bounding shape detection analysis to more efficiently allocate its processing resources. Ephemeral objects may refer to temporary obstacles such as debris that may suddenly appear on the road. Additionally, or alternatively, ephemeral objects may correspond to artifacts in an imaging or other detection system. Such artifacts may correspond to a miscoloring in the environment (e.g., a black spot on the road), an inconsistency in the environment (e.g., fog, dust, snow), or mechanical artifacts. Such mechanical artifacts may include lens flares, motion blurs, chromatic aberrations, lens distortions, More patterns, dead pixels in the imager, ghosting, or other aberrations. By filtering ephemeral objects, the autonomous vehicle may focus the onboard computing resources of the autonomous vehicle on analyzing objects that are more likely to include extensions. This allows for more efficient usage of the limited computing resources that are onboard the autonomous vehicle.

Based on the data indicative of the object (e.g., sensor data 204), the autonomous vehicle may generate a first bounding shape 402 enclosing the object. As described herein, the first bounding shape 402 may include a shape that matches the general boundaries/perimeter of the object . For instance, the first bounding shape 402 may represent a canonical shape fit tightly to the main volume of the vehicle travelling near the autonomous vehicle. The first bounding shape 402 may be projected on the sensor data 204 (e.g., image, point cloud).

The method 700 may include generating the first bounding shape 402 based on a classification of the object. For example, the dimensions of the first bounding shape 402 may be based on the classification of the object as a vehicle (e.g., sedan, pick-up truck), trailer, bicycle, or another object.

At 704, the method 700 may include identifying, based on the data indicative of the object and the first bounding shape 402, an extension of the object outside the boundary corresponding to the shape of the object. For instance, the autonomous vehicle may project the first bounding shape 402 onto the sensor data 204 and detect an extension that extends beyond the first bounding shape 608 based on a portion of the sensor data 204 (e.g., image pixels, LIDAR point cloud) indicating the presence of the extension outside the first bounding shape 402. As described herein, example extensions may include a protrusion of an item being transported by the object (e.g., a pole extending from the bed of a pick-up truck), or a protrusion of a component of the object 602 (e.g., a trailer hitch).

At 706, the method 700 may include generating, based on the first bounding shape 402, a second bounding shape 404 for the object, the extension of the object enclosed in an interior region of the second bounding shape 404. To do so, the autonomous vehicle may iteratively transform one or more portions (e.g., sides) of the first bounding shape 402. The second bounding shape 404 may include the resulting transformed shape. For example, autonomous vehicle may utilize a model (e.g., trained model) to determine a first extension located at a first side of the first bounding shape 402 and transform the first side by shifting the first side away (e.g., upwards, outward, etc.) from the centroid of the first bounding shape 402 until the entirety of the first extension (e.g., including the first extension’s outermost surface from the centroid) is encapsulated within the interior region of the first bounding shape 402.

The autonomous vehicle may similarly transform a second side the first bounding shape 402 to encapsulate the a second extension located at the second side. The second bounding shape 404 may be generated as a result of the iterative transformations. The first and second sides may be sides of the first bounding shape 404 that exceed a visibility threshold of the model. As described herein, the visibility threshold may be tuned based on real world observations utilizing similar sensor modalities as that of the autonomous vehicle.

FIG. 7B depicts an example method 701 for performing a transformation on the first bounding shape 402 to generate the second bounding shape 404. The autonomous vehicle may determine which portions of the first bounding shape 402 to transform based on the location of the detected extensions.

At 712, the method 701 may include determining, based on the extension, a first portion of the first bounding shape 402 at which the extension is located. For instance, the autonomous vehicle may analyze the sensor data 204 depicting a vehicle (e.g., a large pick-up truck) and a first bounding shape 402 encapsulating the vehicle. The sensor data 204 and the first bounding shape 402 may indicate that a pole extending from the back of the vehicle is located at a first portion of the first bounding shape 402 and that a flag extending from a right side of the vehicle is located at a second portion of the first bounding shape 402.

At 714, the method 701 may include performing a transformation on the first portion of the first bounding shape 402. In response to detecting that the pole extends from the back of the vehicle, the autonomous vehicle (e.g., the shape detection model 403) may perform one or more transformations of the first portion of the first bounding shape 402 that corresponds to the back of the vehicle. For example, the first portion of the first bounding shape 402 may be a first side of the first bounding shape 402 (e.g., corresponding to the back of the vehicle), and the transformation may include shifting the first side of the first bounding shape 402 away from a centroid of the first bounding shape 402. As described herein, the first side may be shifted away from the centroid until the entire pole extending from the back of the vehicle is included in the interior region of the transformed bounding shape. This process may continue with the other portions of the first bounding shape 402 that include extensions.

At 716, the method 701 may include generating the second bounding shape 404 to include the first portion of the first bounding shape 402 that has been transformed, such that an outer surface of the extension is included in the interior region defined by the second bounding shape 404. For instance, the boundaries of the second bounding shape 404 may be defined by the transformed first bounding shape 402, including any transformed sides that were shifted away from the centroid of the first bounding shape 402 to encapsulate the pole extending from the back of the vehicle.

In some implementations, the autonomous vehicle may determine which portions of the first bounding shape 402 to transform based on the relevancy of the respective portion to the motion planning of the autonomous vehicle. In an example, the autonomous vehicle may determine whether or not to transform portion(s) of the first bounding shape 402 based on a distance between the autonomous vehicle 402 and the object. Additionally, or alternatively, the autonomous vehicle may determine that a first portion of the first bounding shape 402 is within a field of view of a sensor 202 of the autonomous vehicle 604, as described herein. Thus, the autonomous vehicle may select the first portion of the first bounding shape 402 for transformation.

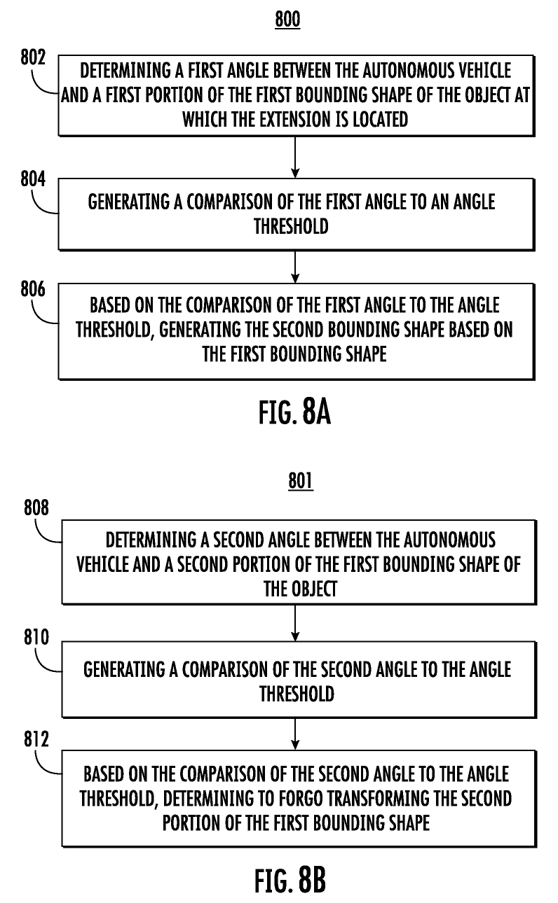

In some implementations, the autonomous vehicle 604 may determine whether or not to transform portion(s) of the first bounding shape 402 based on an angle between the autonomous vehicle and the respective portion(s) of the first bounding shape 402. For example, FIGS. 8A-B depict example methods 800, 801 for determining whether or not to transform a particular portion of a bounding shape based on an angle.

At 802, the method 800 may include determining a first angle between the autonomous vehicle and a first portion of the first bounding shape 402 of the object at which the extension is located. For example, as described herein, a local frame may include a first axis running from the centroid of the object through a side including the extension. The first axis may represent zero degrees. The first angle may be the angle from the first axis to a point associated with the autonomous vehicle (e.g., a centroid of the autonomous vehicle).

By way of example, the local frame may include an axis extending from the centroid of the first bounding shape 402 to a first portion (e.g., a front portion of the extension), representing zero degrees and an axis extending from the centroid of the first bounding shape 402 to a second portion (e.g., a back of the extension) representing 180 degrees. An axis extending from the centroid of the first bounding shape 402 to a third portion (e.g., a left side of the extension), may represent 90 degrees within the local frame. An axis extending from the centroid of the first bounding shape 402 to a fourth portion (e.g., a right side of the extension), may represent 270 degrees within the local frame. The autonomous vehicle may determine (e.g., based on a trained model) that the first angle between the autonomous vehicle and axis extending through the first portion is forty-five degrees, with respect to the local frame. The first angle may correspond to an angle of visibility of the first portion, for the autonomous vehicle.

At 804, the method 800 may include generating a comparison of the first angle to an angle threshold. As described herein, the angle threshold may indicate a value (e.g., 110 degrees) that an angle is to meet in order for the autonomous vehicle to transform the associated portion of the first bounding shape 402. The angle threshold may indicate, for example, whether a position (e.g., angle) of the autonomous vehicle (e.g., sensor(s) 202) is either sufficient or insufficient to obtain a threshold level of sensor data 204 depicting the location of the extension relative to a portion of the first bounding shape 402.

In some implementations, the angle between the autonomous vehicle and one or more portions of the first bounding shape 402 may change over time. For instance, as the autonomous vehicle travels along a given route or trajectory, the autonomous vehicle may change lanes (e.g. to avoid a vehicle or other object), make a turn, or perform another maneuver. Sensor data 204 captured at each time step may adjust the angle. By way of example, at a first time step, the first angle between the autonomous vehicle the angle of a pole extending from the rear of a vehicle may be forty-five degrees, as the autonomous vehicle is positioned to the diagonal back, left of the vehicle in an adjacent lane. The first angle at the first step may be less than the angle threshold. At a second time step, the first angle may increase above the angle threshold if the autonomous vehicle passes the vehicle, such that the autonomous vehicle is located at to the diagonal front, left of the vehicle.

The angle may dictate the level of transformation of the portion of the first bounding shape 402. For instance, the full extent (e.g., distance, size) of the extension protruding from the left side of the vehicle outside the first bounding shape 402 may be depicted in sensor data 204 from a front angle or a rear angle. However, the only a partial view of the extension protruding from the left side of the vehicle outside the first bounding shape 402 may be depicted if the vehicle is on the right side (e.g., side angle) of the vehicle.

At 806, the method 800 may include, based on the comparison of the first angle to the angle threshold, generating the second bounding shape 404 based on the first bounding shape 402. For instance, the comparison of the first angle to the angle threshold may indicate that the first angle is less than the angle threshold. Based on this, the autonomous vehicle may transform the first bounding shape 402 by manipulating the portion (e.g., rear side) of the first bounding shape 402 at which the extended pole is located, so that the interior region of the bounding shape encloses the entire pole (e.g., represented in the sensor data 204). As described herein, the second bounding shape 404 may include the transformed version of the first bounding shape 402. The second bounding shape 404 may include a larger region than the first bounding shape 402.

The autonomous vehicle may not transform certain portions of the first bounding shape 402 to generate the second bounding shape 404. The autonomous vehicle may forgo transforming certain portions of the first bounding shape 402 for the generation of the second bounding shape 404. For instance, the autonomous vehicle may predict extensions located at portions of the first bounding shape 402 that are not visible to, or are lower than the visibility threshold of, the autonomous vehicle. By way of example, the autonomous vehicle may be trained to predict a mirror extension is located at a portion of the first bounding shape 402 away from (e.g., far side) the autonomous vehicle based on a mirror extensions at a portion of the first bounding shape 402 closest (e.g. near side) to the autonomous vehicle. However, based on the predicted mirror extension being located at a portion of the first bounding shape 402 away from the autonomous vehicle (e.g., a far side below a visibility threshold), the autonomous vehicle may not transform the portion of the first bounding shape 402 away from (e.g., far side) the autonomous vehicle based on the extension having no or minimal impact on a candidate trajectory or motion plan for the autonomous vehicle.

For example, with reference FIG. 8B, at 808, the method 801 may include determining a second angle between the autonomous vehicle and a second portion of the first bounding shape of the object. For instance, an object may include multiple extensions. The aforementioned example vehicle (e.g., pick-up truck) may include a flag extending from the vehicle. The flag may extend outside a second portion (e.g., right side) of the vehicle. The local frame may include a second axis extending from the centroid of the object to the second portion. The axis may represent two-hundred, seventy degrees in the local frame. The second angle between the autonomous vehicle and the second portion (e.g., beyond which the flag is extending) may be two-hundred, twenty five degrees.

At 810, the method 801 may include generating a comparison of the second angle to the angle threshold. For instance, the autonomous vehicle may compare the second angle (e.g., 225 degrees) to the angle threshold (e.g., 110 degrees) to determine whether the second angle satisfies the angle threshold. Satisfaction of the angle threshold may depend on whether the threshold is indicative of a lower limit, upper limit, or range and whether the particular angle is at or above/below the limit, or at or within/outside the range.

At 812, the method 801 may include, based on the comparison of the second angle to the angle threshold, determining to forgo transforming the second portion of the first bounding shape 402. For instance, the autonomous vehicle may determine that the comparison of the second angle (e.g., 225 degrees) to the angle threshold (e.g., 110 degrees) indicates that the second angle is greater than the angle threshold. Thus, the autonomous vehicle may determine that the second angle does not satisfy the angle threshold. This may indicate that the extension has minimal or no impact on the motion planning of the autonomous vehicle, at the current time frame. The autonomous vehicle may forgo transforming the second portion of the first bounding shape 404, such that the interior region may not enclose the flag extending from the right side of the vehicle.

Returning to FIG. 7, at 708, the method 700 may include generating, based on the second bounding shape 404, a motion plan 407 for the autonomous vehicle. As described herein, the motion plan 407 may include one or more parameters to control the motion of the autonomous vehicle relative to the second bounding shape 404. For example, the motion plan 407 may include constraints to control the motion of the autonomous vehicle to avoid the vehicle and the pole extending from the rear. The parameters may define certain data that may be translated by the control system 260 for instructing the control devices of the autonomous vehicle. This may include, for example, parameters that indicate steering adjustments/positions/angles, throttling/acceleration targets, speed/velocity targets, braking forces, or other parameters. As described herein, the parameters may include a trajectory for the autonomous vehicle to follow.

Additionally, or alternatively, the autonomous vehicle may generate a motion plan 407 based on the first bounding shape 402. In an example, the autonomous vehicle may determine that the distance between the autonomous vehicle and the object is greater than a distance threshold. Based on this determination, the autonomous vehicle may forgo the generation of a second bounding shape 404 to capture extension(s) of the object. Thus, the planning system 250 may be provided with only the first bounding shape 402 for a given object.

In another example, the autonomous vehicle may generate the motion plan 407 based on the first bounding shape 402 and the second bounding shape 404 for an object. The planning system 250 may be provided with the first bounding shape 402 and the second bounding shape 404 for a given object. The autonomous vehicle may perform a first computation based on the first bounding shape 402 and a second computation based on the second bounding shape 404. The first computation may be different from the second computation.

For example, the autonomous vehicle may determine, based on the second bounding shape 404, a clearance distance for passing the object which includes the relevant extensions. The autonomous vehicle may determine, based on the first bounding shape 402, an estimated position of the object within a roadway. The estimated position may indicate, for example, a lane or other portion of a roadway in which the object is traveling. The existence of an extension from the vehicle may be less material for determination of the estimated position of the object within network of lanes. Thus, the first bounding shape may be appropriate for such computation. The autonomous vehicle may generate, also based on the estimated position of the object within the roadway, the motion plan 407 for the autonomous vehicle.

At 710, the method 700 may include providing one or more instructions to control the motion of the autonomous vehicle in accordance with the one or more parameters of the motion plan 407. For instance, planning system 250 may output instructions to the control system 260 to control the motion of the autonomous vehicle in accordance with the one or more parameters of the motion plan 407. The autonomous vehicle may operate according to the motion plan 407 (e.g., the generated trajectory) to avoid interfering with the object and the extension (e.g., as the autonomous vehicle changes lanes, exits a roadway).

As described herein, the autonomous vehicle may generate the second boundary shape 404 based on a model. The model may include a model trained using machine-learning techniques and training data. The training data may be generated based on aspects of the technology of the present disclosure.

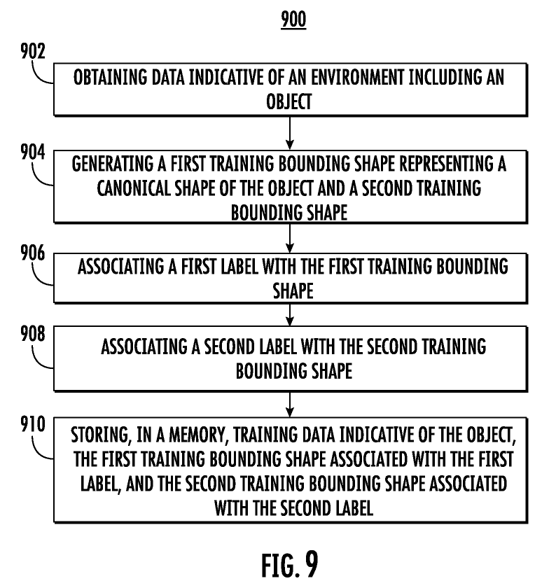

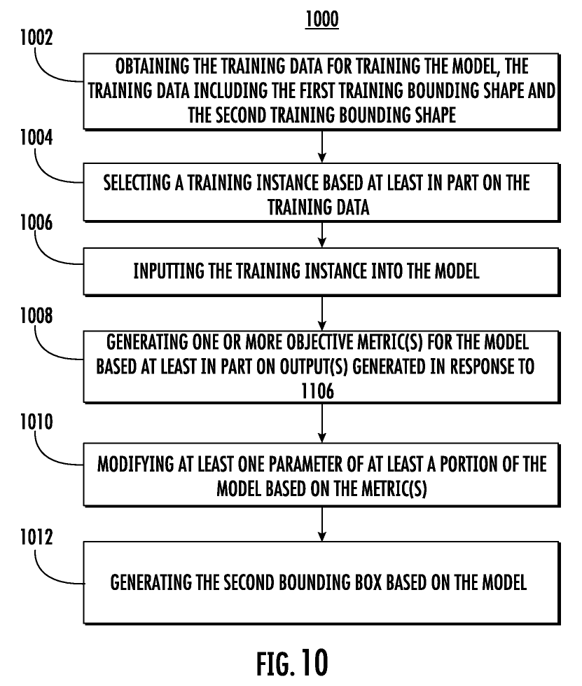

FIG. 9 is a flowchart of an example method for generating training data, according to some implementations of the present disclosure. At 902, the method 900 may include obtaining data indicative of an environment including an object. For instance, the shape detection model 403 may be trained through the use of a training computing system. The training computing system may include one or more model trainers, as described with reference to FIG. 11. The training computing system may obtain data depicting an object in the surrounding environment of an autonomous vehicle. This may include various types of data.

For instance, sensor data, which may be used as a basis for training data, may be collected using one or more autonomous platforms (e.g., autonomous platform 110) or the sensors thereof as the autonomous platform is within its environment. By way of example, the data may be collected using one or more autonomous vehicles or sensors thereof as the vehicles operate along one or more travel ways. In some example methods, the data may be collected using other sensors, such as mobile-device-based sensors, ground-based sensors, aerial-based sensors, satellite-based sensors, or substantially any sensor interface configured for obtaining or recording measured data. In some example methods, data may be collected from public sources that are non-specific to shape detections. For instance, data may be collected from publicly available online sources.

In some implementations, the training computing system may generate training data based on perception output data. Perception output data may include data that is output from a perception system of an autonomous vehicle. In some example, the perception output data may include certain metadata that is produced by the perception system (or the functions thereof). For instance, perception output data may include metadata associated to characteristics of objects in image frames captured of an environment. In some example methods, perception output data may include vehicle tracks. The tracks may include a bounding shape of the actor and state data. State data may include the position, velocity, acceleration, of other characteristics of an actor at the time at which the actor was perceived.

In some implementations, the training computing system may generate training data based on log data. Log data may include data that is obtained from one or more autonomous vehicles and downloaded to an offline system. The log data may be logged versions of sensor data, perception output data, or other data. The log data may be stored in an accessible memory and may be extracted to produced specific combinations of attributes for training data.

In some implementations, the training computing system may generate training data based on simulated data. The simulated data may be collected during one or more simulation instances/runs. The simulation instances may simulate a scenario in which a simulated autonomous vehicle traverses a simulated environment and captures simulated perception output data of the simulated, virtual environment. Simulated actors with extensions within the scenario such that the resultant simulated log data is reflective of the simulated perception output data. In this way, simulated log data may include objects with extensions, which may then be used for training data generation.

At 904, the method 900 may include generating a first training bounding shape representing a canonical shape of the object and a second training bounding shape. For instance, the training computing system may process the sensor data and generate the first training bounding shape (e.g., bounding box) based on a model or algorithm structured to determine the classification of the object and generate a canonical shape to encapsulate the object depicted in the sensor data. The canonical shape may be tightly fit to the main volume of the object depicted in the sensor data.

The training computing system may analyze the sensor data and the first training bounding shape to identify one or more extensions of the object. By way of example, the object may include a trailer with a wide load extending outside the walls of the trailer. The wide load may not fully fit within the first training bounding shape. The training computing system may generate a second training bounding shape, enclosing the wide load extensions, based on the systems and methods described herein.

At 906, the method 900 may include associating a first label with the first training bounding shape. For instance, the training computing system may generate a label within the data to identify the first training bounding shape, projected onto the sensor data. The label may be generated manually (e.g., based on user input) or programmatically.

At 908, the method 900 may include associating a second label with the second training bounding shape. The training computing system may generate a second label to identify the second training bounding shape, projected onto the sensor data. The training computing system may generate one or more labels to respectively identify the one or more extensions of the object that are outside the first training bounding shape.

At 910, the method 900 may include storing, in a memory, training data indicative of the object, the first training bounding shape associated with the first label, and the second training bounding shape associated with the second label. The memory may be accessible by the training computing system to train a model based on the training data.

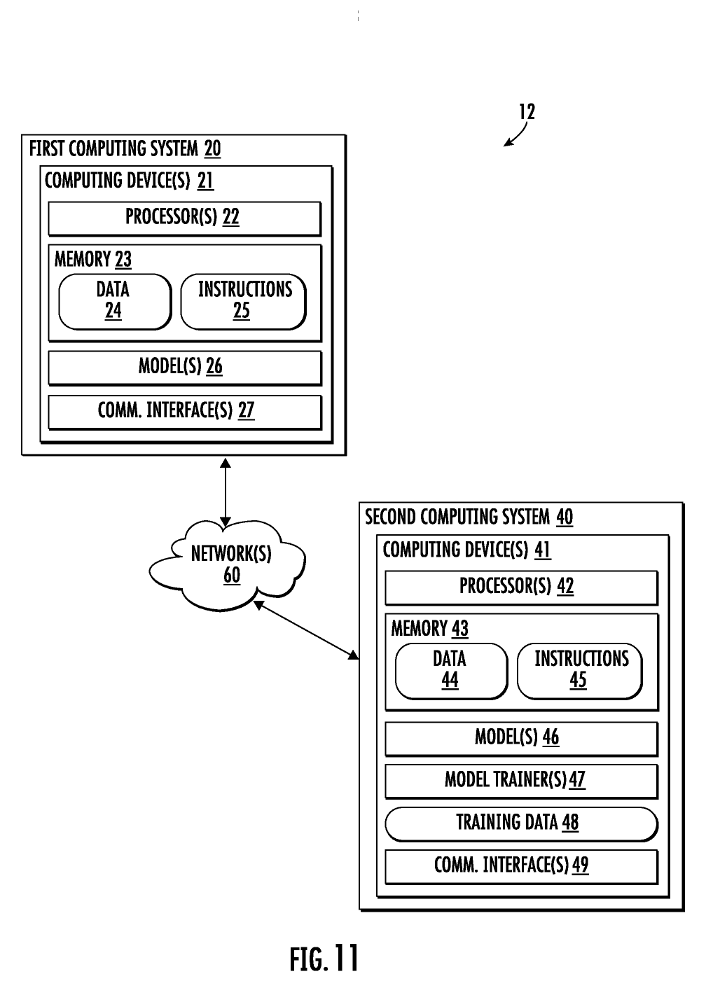

FIG. 10 is a flowchart of an example method 1000 for training a machine-learned model and implementing the model at runtime, according to some implementations of the present disclosure.

At 1002, the method 1000 may include obtaining the training data for training the model. The training data may include labeled training data. The labeled training data may be indicative of a first training shape representing a canonical shape of a training object and a second training shape representing a shape of the training object that includes an extension of the training object. The labeled training data may be generated based on the method 900.

The training data may include sensor data, perception output data, log data, simulation data, or other types of data. The training data may include vehicle state data, tracks, image frames captured during instances of real-world or simulated driving, associated times in which the objects in the environments were perceived, and other information.

The training data may cover objects and extensions from different aspects. For example, training data may cover numerous vehicle extensions and appearances. Training data may be biased towards close range extensions that are easy to classify. Training data may cover rich scenes involving extensions including day and night, highway and urban environments, and various other traffic conditions.

In some examples, the training data may include augmented training data. Data augmentation may be applied to training data by applying transformations on raw image data with cropping, flipping, rotation, resizing, color jitting, or other adjustments. Data augmentation may include tweaking a vehicle track bounding shape in a statistical way by sampling a state distribution to generate a new track bounding shape. For instance, training data may contain the track’s state coordinates x, y, z of the bounding shape center and the length, width, and height of the bounding shape. The track’s state may fit a sampled multivariate normal distribution, and such changes may affect the image cropping positions to augment the dataset. Augmented training data may ensure the augmented data set is natural and very likely to occur in the real world. In some example methods, augmented training data may use a sampling ratio multiplier on positive targets and negative targets.

In some example methods, training data may be processed by a data engine. The data engine may be used to mine data (e.g., log data) to find events of vehicle extension detections. In some examples, the positive extension events may be added to the training data for further training of the shape detection model 403. In some example methods, false positive extension events may be added to the training data for further training. For instance, a false positive event rate may be measured for improvement and change in recall comparative to a baseline.

The training data may include labeled training data. For instance, the training data may include label data indicating that an object in a respective image frame includes an extension, a type of extension, an ephemeral, or other feature. In some examples, the training data may include labels that indicate that a variety of other details (e.g. type of vehicle) in a respective image frame.

Labeling may include four-dimensional (4D) labeling (e.g., 3D bounding box around the LIDAR points on the object, as a function of time) and two-dimensional (2D) labeling (e.g., 2D bounding box on the object within the forward camera image). The 4D and 2D labels may be associated and used to generate a sequence of images (e.g., a collage video) of each individual object. The training data may include a plurality of training sequences divided between multiple datasets (e.g., a training dataset, a validation dataset, or testing dataset). Each training sequence may include a plurality of pre-recorded perception datapoints, point clouds, images, or other information.

At 1004, the method 1000 may include selecting a training instance based at least in part on the training data. For instance, a training computing system may select a labeled training dataset to train the machine-learned shape detection model 403. This labeled training data may include objects or scenarios that may be commonly viewed by the shape detection model 403 or edge cases for which the model should be trained. For example, a training instance can include a vehicle, on a highway, pulling a trailer with a wide load extending from the trailer.

Training instances may also be selected based on certain targets. Targets may include true positive and false positive targets. This may help improve the model irrespective of whether they were true positive or false positive events. For instance, targets may include positive targets which may indicate a positive shape detection. In some example methods, targets may include negative targets which may indicate a negative shape detection. In some examples, a negative target may include non-extension detections.

Targets may include positive and negative targets in a variety of contexts including day and night, highway and urban, and various other traffic conditions. In some examples, targets may be generated from real-world or simulated driving. In some example methods, targets may be generated from public sources that are non-specific to shape detections.

At 1106, the method 1100 may include inputting the training instance into the model. For instance, the shape detection model 403 may receive the training data and extract labels to determine positive and negative extension detections. The machine-learned shape detection model 403 may process the training data and generate machine-learned output data. In some examples, the machine-learned output data may include a baseline. In some examples, the machine-learned output data may include oversampling within a training set.

Model training may be based on one or more loss functions. For example, the model training may be performed as an optimization process to minimize a set of loss functions with respect to the training data. The loss function may include components for different tasks. For example, the loss function components may include a pose loss, a category loss, a validity loss, or other types of loss.

The loss function components may include center and canonical extents (shape) loss. For example, this loss may be determined based on a predicted shape bₚ and labeled shape bₗ in a predicted frame. The labels and predictions may be represented in an input track frame. A transform may be applied to transform the labels/predictions into the predicted frame from the input track frame. The negative log likelihood (ℒ) on the multivariate normal of the label and predicted distribution of a track may be computed in the predicted frame.

The loss function components may include an observed extents loss. Observed shape extents may be varying for each side of the label (e.g., not necessarily equal on the port/starboard side, or bow/stern).

A loss may be computed on each side of a training bounding shape. For example, loss may be computed on the sides of the second training bounding shape that are visible from the perspective of the autonomous vehicle. To compute this, the training computing system may store the angle pointing from the object label to the autonomous vehicle, and compare the angle to the angle pointing from the label center to each side, in a local frame. The smaller the minimum difference in this angle, the more visible the side.

For instance, if the autonomous vehicle is directly to the diagonal front left side of the labeled object, then in the local frame, the angle from the labeled object to the autonomous vehicle may be forty-five degrees. The angle of the vector pointing from the object center to the bow side may be considered zero degrees, and to the port side may be considered ninety degrees. The differences here are forty-five degrees to both sides, indicating good visibility. In contrast, the vector pointing from object center to the stern may be considered one hundred, eighty degrees, and to the starboard may be considered two hundred, seventy degrees. The minimum angle difference with these sides is one hundred, thirty-five degrees, which may indicate poor/no visibility. A training angle threshold (e.g., 110 degrees) may be used, above which the training computing system does not loss the side.

In some implementations, the training computing system may only apply loss on labels that are within a certain distance to the autonomous vehicle (e.g., because secondary bounding shapes may not be needed at longer ranges). The loss applied may be a smooth L1 loss to each predicted side distance. Lo = label_in_distance_range * (smooth_l1(ol, bow, op, bow) * bow_visible + smooth_l1(ol, stern, op, stern) * stern_visible + smooth_l1(ol, port, op, port) * port_visible + smooth_l1(ol, starboard, op, starboard) * starboard_visible.

At 1008, the method 1000 may include generating one or more objective metrics for the model based at least in part on outputs generated in response to 1106. The objective metrics may include a score, precision metric, or other benchmarking techniques for measuring the performance of the model. For instance, the output may be compared to the training data to determine the progress of the training and the precision of the shape detection model 403.

At 1010, the method 1100 may include modifying at least one parameter of at least a portion of the model based on the metrics. For instance, the training computing system may modify at least one hyperparameter of the machine-learned shape detection model 403. The hyperparameters of the shape detection model 403 may be tuned to improve the max-F1 score or other metrics. A data engine may continuously improve the model by adding more and more data over time during training and re-training. In some example methods, the shape detection model 403 may be trained in an end-to-end manner. For example, in some implementations, the shape detection model 403 may be fully differentiable. After being updated, the shape detection model 403 or the operational system including the model may be provided for validation.

After training, the shape detection model 403 may be deployed for use during runtime. For example, at 1012, the method 1000 may include generating a second bounding box based on the model, the model being trained based on the labeled training data including a training object with a training extension. An autonomous vehicle may provide input data indicative of an object into the shape detection model 403. In some implementations, the input data may be indicative of a first bounding shape (e.g., canonical bounding shape). The shape detection model 403 may be trained to process the data indicative of the object and the first bounding shape and identify an extension. The shape detection model 403 may be trained to generate, based on the first bounding shape and the transformation techniques described herein, the second bounding shape enclosing the entirety of at least one extension within the interior region of the second bounding shape. The autonomous vehicle may, from the shape detection model 403, output data indicative of the second bounding shape. The output data may also include the first bounding shape.

FIG. 11 is a block diagram of an example computing ecosystem 12 according to example implementations of the present disclosure. The example computing ecosystem 12 may include a first computing system 20 and a second computing system 40 that are communicatively coupled over one or more networks 60. In some implementations, the first computing system 20 or the second computing 40 may implement one or more of the systems, operations, or functionalities described herein for validating one or more systems or operational systems (e.g., the remote system(s) 160, the onboard computing system(s) 180, the autonomy system(s) 200).

In some implementations, the first computing system 20 may be included in an autonomous platform and be utilized to perform the functions of an autonomous platform as described herein. For example, the first computing system 20 may be located onboard an autonomous vehicle and implement autonomy system(s) for autonomously operating the autonomous vehicle. In some implementations, the first computing system 20 may represent the entire onboard computing system or a portion thereof (e.g., the localization system 230, the perception system 240, the planning system 250, the control system 260, or a combination thereof). In other implementations, the first computing system 20 may not be located onboard an autonomous platform. The first computing system 20 may include one or more distinct physical computing devices 21.

The first computing system 20 (e.g., the computing device(s) 21 thereof) may include one or more processors 22 and a memory 23. The one or more processors 22 may be any suitable processing device (e.g., a processor core, a microprocessor, an ASIC, a FPGA, a controller, a microcontroller) and may be one processor or a plurality of processors that are operatively connected. The memory 23 may include one or more non-transitory computer-readable storage media, such as RAM, ROM, EEPROM, EPROM, one or more memory devices, flash memory devices, or combinations thereof.

The memory 23 may store information that may be accessed by the one or more processors 22. For instance, the memory 23 (e.g., one or more non-transitory computer-readable storage media, memory devices) may store data 24 that may be obtained (e.g., received, accessed, written, manipulated, created, generated, stored, pulled, downloaded). The data 24 may include, for instance, sensor data, map data, data associated with autonomy functions (e.g., data associated with the perception, planning, or control functions), simulation data, or any data or information described herein. In some implementations, the first computing system 20 may obtain data from one or more memory device(s) that are remote from the first computing system 20.

The memory 23 may store computer-readable instructions 25 that may be executed by the one or more processors 22. The instructions 25 may be software written in any suitable programming language or may be implemented in hardware. Additionally, or alternatively, the instructions 25 may be executed in logically or virtually separate threads on the processor(s) 22.

For example, the memory 23 may store instructions 25 that are executable by one or more processors (e.g., by the one or more processors 22, by one or more other processors) to perform (e.g., with the computing device(s) 21, the first computing system 20, or other system(s) having processors executing the instructions) any of the operations, functions, or methods/processes (or portions thereof) described herein. For example, operations may include implementing system validation (e.g., as described herein).

In some implementations, the first computing system 20 may store or include one or more models 26. In some implementations, the models 26 may be or may otherwise include one or more machine-learned models (e.g., a machine-learned shape detection model). As examples, the models 26 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the first computing system 20 may include one or more models for implementing subsystems of the autonomy system(s) 200, including any of: the localization system 230, the perception system 240, the planning system 250, or the control system 260.

In some implementations, the first computing system 20 may obtain the one or more models 26 using communication interface(s) 27 to communicate with the second computing system 40 over the network(s) 60. For instance, the first computing system 20 may store the model(s) 26 (e.g., one or more machine-learned models) in the memory 23. The first computing system 20 may then use or otherwise implement the models 26 (e.g., by the processors 22). By way of example, the first computing system 20 may implement the model(s) 26 to localize an autonomous platform in an environment, perceive an autonomous platform’s environment or objects therein, plan one or more future states of an autonomous platform for moving through an environment, control an autonomous platform for interacting with an environment, perform the techniques and processes described herein, or perform other functions.

The second computing system 40 may include one or more computing devices 41. The second computing system 40 may include one or more processors 42 and a memory 43. The one or more processors 42 may be any suitable processing device (e.g., a processor core, a microprocessor, an ASIC, a FPGA, a controller, a microcontroller) and may be one processor or a plurality of processors that are operatively connected. The memory 43 may include one or more non-transitory computer-readable storage media, such as RAM, ROM, EEPROM, EPROM, one or more memory devices, flash memory devices, and combinations thereof.

The memory 43 may store information that may be accessed by the one or more processors 42. For instance, the memory 43 (e.g., one or more non-transitory computer-readable storage media, memory devices) may store data 44 that may be obtained. The data 44 may include, for instance, sensor data, model parameters, map data, simulation data, simulated environmental scenes, simulated sensor data, data associated with vehicle trips/services, or any data or information described herein. In some implementations, the second computing system 40 may obtain data from one or more memory devices that are remote from the second computing system 40.

The memory 43 may also store computer-readable instructions 45 that may be executed by the one or more processors 42. The instructions 45 may be software written in any suitable programming language or may be implemented in hardware. Additionally, or alternatively, the instructions 45 may be executed in logically or virtually separate threads on the processors 42.

For example, the memory 43 may store instructions 45 that are executable (e.g., by the one or more processors 42, by the one or more processors 22, by one or more other processors) to perform (e.g., with the computing devices 41, the second computing system 40, or other system(s) having processors for executing the instructions, such as computing devices 21 or the first computing system 20) any of the operations, functions, or methods/processes described herein. This may include, for example, the functionality of the autonomy system(s) 200 (e.g., localization, perception, planning, control) or other functionality associated with an autonomous platform (e.g., remote assistance, mapping, fleet management, trip/service assignment and matching). This may also include, for example, validating a machined-learned operational system.

In some implementations, the second computing system 40 may include one or more server computing devices. In the event that the second computing system 40 includes multiple server computing devices, such server computing devices may operate according to various computing architectures, including, for example, sequential computing architectures, parallel computing architectures, or some combination thereof.

Additionally, or alternatively to, the model(s) 26 at the first computing system 20, the second computing system 40 may include one or more models 46. As examples, the model(s) 46 may be or may otherwise include various machine-learned models (e.g., a machine-learned shape detection model) such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the second computing system 40 may include one or more models of the autonomy system(s) 200.

In some implementations, the second computing system 40 or the first computing system 20 may train one or more machine-learned models of the model(s) 26 or the model(s) 46 through the use of one or more model trainers 47 and training data 48. The model trainer(s) 47 may train any one of the model(s) 26 or the model(s) 46 using one or more training or learning algorithms. One example training technique is backwards propagation of errors. In some implementations, the model trainer(s) 47 may perform supervised training techniques using labeled training data. In other implementations, the model trainer(s) 47 may perform unsupervised training techniques using unlabeled training data. In some implementations, the training data 48 may include simulated training data (e.g., training data obtained from simulated scenarios, inputs, configurations, environments). In some implementations, the second computing system 40 may implement simulations for obtaining the training data 48 or for implementing the model trainer(s) 47 for training or testing the model(s) 26 or the model(s) 46. By way of example, the model trainer(s) 47 may train one or more components of a machine-learned model for the autonomy system(s) 200 through unsupervised training techniques using an objective function (e.g., costs, rewards, heuristics, constraints). In some implementations, the model trainer(s) 47 may perform a number of generalization techniques to improve the generalization capability of the model(s) being trained. Generalization techniques include weight decays, dropouts, or other techniques.

For example, in some implementations, the second computing system 40 may generate training data 48 according to example aspects of the present disclosure. For instance, the second computing system 40 may generate training data 48. For instance, the second computing system 40 may implement methods according to example aspects of the present disclosure. The second computing system 40 may use the training data 48 to train model(s) 26. For example, in some implementations, the first computing system 20 may include a computing system onboard or otherwise associated with a real or simulated autonomous vehicle. In some implementations, model(s) 26 may include perception or machine vision model(s) configured for deployment onboard or in service of a real or simulated autonomous vehicle. In this manner, for instance, the second computing system 40 may provide a training pipeline for training model(s) 26.

The first computing system 20 and the second computing system 40 may each include communication interfaces 27 and 49, respectively. The communication interfaces 27, 49 may be used to communicate with each other or one or more other systems or devices, including systems or devices that are remotely located from the first computing system 20 or the second computing system 40. The communication interfaces 27, 49 may include any circuits, components, software, or other components for communicating with one or more networks (e.g., the network(s) 60). In some implementations, the communication interfaces 27, 49 may include, for example, one or more of a communications controller, receiver, transceiver, transmitter, port, conductors, software or hardware for communicating data.

The network(s) 60 may be any type of network or combination of networks that allows for communication between devices. In some implementations, the network(s) may include one or more of a local area network, wide area network, the Internet, secure network, cellular network, mesh network, peer-to-peer communication link or some combination thereof and may include any number of wired or wireless links. Communication over the network(s) 60 may be accomplished, for instance, through a network interface using any type of protocol, protection scheme, encoding, format, packaging, or combination thereof.

FIG. 10 illustrates one example computing ecosystem 10 that may be used to implement the present disclosure. Other systems may be used as well. For example, in some implementations, the first computing system 20 may include the model trainer(s) 47 and the training data 48. In such implementations, the model(s) 26, 46 may be both trained and used locally at the first computing system 20. As another example, in some implementations, the computing system 20 may not be connected to other computing systems. Additionally, components illustrated or discussed as being included in one of the computing systems 20 or 40 may instead be included in another one of the computing systems 20 or 40.

Computing tasks discussed herein as being performed at computing device(s) remote from the autonomous platform (e.g., autonomous vehicle) may instead be performed at the autonomous platform (e.g., via a vehicle computing system of the autonomous vehicle), or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but”. It should be understood that such conjunctions are provided for explanatory purposes only. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. may be used to illustrate operations. Such identifiers are provided for the ease of the reader and do not denote a particular order of steps or operations. An operation illustrated by a list identifier of (a), (i), etc. may be performed before, after, or in parallel with another operation illustrated by a list identifier of (b), (ii), etc.

What is claimed is:

1. A computer-implemented method comprising:
generating, based on data indicative of an object within an environment of an autonomous vehicle, a first bounding shape for the object, the first bounding shape indicating a boundary corresponding to a shape of the object;
identifying, based on the data indicative of the object and the first bounding shape, an extension of the object outside the boundary corresponding to the shape of the object;
generating, based on the first bounding shape, a second bounding shape for the object, the extension of the object enclosed in an interior region of the second bounding shape;
generating, based on the second bounding shape, a motion plan for the autonomous vehicle, the motion plan comprising one or more parameters to control the motion of the autonomous vehicle relative to the second bounding shape; and
providing one or more instructions to control the motion of the autonomous vehicle in accordance with the one or more parameters of the motion plan.

2. The computer-implemented method of claim 1, further comprising:
determining, based on the extension, a first portion of the first bounding shape at which the extension is located;
performing a transformation on the first portion of the first bounding shape; and
generating the second bounding shape to include the first portion of the first bounding shape that has been transformed, such that an outer surface of the extension is included in the interior region of the second bounding shape.

3. The computer-implemented method of claim 2, wherein the first portion of the first bounding shape is a first side of the first bounding shape, and wherein the transformation comprises shifting the first side of the first bounding shape away from a centroid of the first bounding shape.

4. The computer-implemented method of claim 2, further comprising:
determining that the first portion of the first bounding shape is within a field of view of a sensor of the autonomous vehicle.

5. The computer-implemented method of claim 1, further comprising:
determining a first angle between the autonomous vehicle and a first portion of the first bounding shape of the object at which the extension is located;
generating a comparison of the first angle to an angle threshold; and
based on the comparison of the first angle to the angle threshold, generating the second bounding shape based on the first bounding shape.

6. The computer-implemented method of claim 5, wherein the comparison of the first angle to the angle threshold indicates that the first angle is less than the angle threshold.

7. The computer-implemented method of claim 6, further comprising:
determining a second angle between the autonomous vehicle and a second portion of the first bounding shape of the object;
generating a comparison of the second angle to the angle threshold; and
based on the comparison of the second angle to the angle threshold, determining to forgo transforming the second portion of the first bounding shape.

8. The computer-implemented method of claim 7, wherein the comparison of the second angle to the angle threshold indicates that the second angle is greater than the angle threshold.

9. The computer-implemented method of claim 1, further comprising:
determining, based on the first bounding shape, an estimated position of the object within a roadway.

10. The computer-implemented method of claim 9, further comprising:
generating, also based on the estimated position of the object within the roadway, the motion plan for the autonomous vehicle.

11. The computer-implemented method of claim 1, further comprising:
determining, based on the data indicative of the object, that the object is not an ephemeral object.

12. The computer-implemented method of claim 1, wherein the extension comprises at least one of a protrusion of an item being transported by the object or a protrusion of a component of the object.

13. The computer-implemented method of claim 1, wherein the second bounding shape comprises a larger region than the first bounding shape.

14. The computer-implemented method of claim 1, further comprising:
generating the first bounding shape based on a classification of the object.

15. The computer-implemented method of claim 1, further comprising:
generating the second bounding box based on a model, the model being trained based on labeled training data, the labeled training data comprising a training object with a training extension,
the labeled training data comprising a first training shape representing a canonical shape of the training object and a second training shape representing a shape of the training object that includes the extension of the training object.

16. An autonomous vehicle (AV) control system comprising:
one or more processors; and
one or more tangible, non-transitory, computer-readable media that store instructions that are executable by the one or more processors to perform operations comprising:
generating, based on data indicative of an object within an environment of an autonomous vehicle, a first bounding shape for the object, the first bounding shape indicating a boundary corresponding to a shape of the object;
identifying, based on the data indicative of the object and the first bounding shape, an extension of the object outside the boundary corresponding to the shape of the object;
generating, based on the first bounding shape, a second bounding shape for the object, the extension of the object enclosed in an interior region of the second bounding shape;
generating, based on the second bounding shape, a motion plan for the autonomous vehicle, the motion plan comprising one or more parameters to control the motion of the autonomous vehicle relative to the second bounding shape; and
providing one or more instructions to control the motion of the autonomous vehicle in accordance with the one or more parameters of the motion plan.

17. The AV control system of claim 16, wherein the operations further comprise:
determining a portion of the first bounding shape at which the extension is located;
performing a transformation on the portion of the first bounding shape at which the extension is located; and
generating, based on the portion of the first bounding shape that has been transformed, the second bounding shape, such that an outer surface of the extension is included in the interior region of the second bounding shape.

18. The AV control system of claim 17, wherein the first portion of the first bounding shape is a first side of the first bounding shape, and wherein the transformation comprises shifting the first side of the first bounding shape away from a centroid of the first bounding shape until an entirety of the extension is enclosed in the interior region of the second bounding shape.

19. The AV control system of claim 16, wherein the operations further comprise:
determining a first angle between the autonomous vehicle and a first portion of the first bounding shape of the object at which the extension is located;
generating a comparison of the first angle to an angle threshold; and
based on the comparison of the first angle to the angle threshold, generating the second bounding shape based on the first bounding shape.

20. One or more tangible, non-transitory, computer readable media storing instructions that are executable by one or more processors to perform operations comprising:
generating, based on data indicative of an object within an environment of an autonomous vehicle, a first bounding shape for the object, the first bounding shape indicating a boundary corresponding to a shape of the object;
identifying, based on the data indicative of the object and the first bounding shape, an extension of the object outside the boundary corresponding to the shape of the object;
generating, based on the first bounding shape, a second bounding shape for the object, the extension of the object enclosed in an interior region of the second bounding shape;
generating, based on the second bounding shape, a motion plan for the autonomous vehicle, the motion plan comprising one or more parameters to control the motion of the autonomous vehicle relative to the second bounding shape; and
providing one or more instructions to control the motion of the autonomous vehicle in accordance with the one or more parameters of the motion plan.
